(19) United States
(12) Patent Application Publication
(10) Pub. No.: US 2012/0246085 A1
(43) Pub. Date: Sep. 27, 2012

(54) SYSTEMS AND METHODS FOR ENTITY SPECIFIC, DATA CAPTURE AND EXCHANGE OVER A NETWORK

(76) Inventor: Mark S. Depalma, Bronxville, NY (US)

(21) Appl. No.: 13/236,145

(22) Filed: Sep. 19, 2011

Related U.S. Application Data
(63) Continuation-in-part of application No. 12/669,535, filed on Jan. 19, 2010.
(60) Provisional application No. 60/961,226, filed on Jul. 19, 2007.
(60) Provisional application No. 61/403,603, filed on Sep. 18, 2010.

(51) Int. Cl. G06Q 99/00

(52) U.S. Cl. 705/317

(57) ABSTRACT

A method of accumulating accreditation includes locating evaluations from different sources relating to at least one entity and accumulating evaluations associated with the at least one entity to create an accreditation associated with the at least one entity also comprising systems of supervision and/or compensation.

### CROSS-REFERENCE TO RELATED APPLICATIONS

This application is This application is a continuation-in-part of U.S. application Ser. No. 12/669,535, which was the National Stage of International Application No. PCT/US08/08867, filed Jul. 21, 2008, which claims the benefit of U.S. provisional application No. 60/961,226, filed Jul. 19, 2007. The disclosures of U.S. application Ser. No. 12/669,535 and U.S. provisional application No. 60/961,226 are hereby incorporated by reference. This application claims the benefit of U.S. provisional application No. 61/403,603, filed Sep. 18, 2010, the disclosure of which is hereby incorporated by reference.

The present application incorporates by reference, U.S. Provisional application Ser. No. 61/275,408, entitled, SYSTEMS AND METHODS OF SOCIAL MEDIA OR SOCIAL INTERACTION FOR CREATING AND UTILIZING EVALUATION(S) AND/OR ACCREDITATION(S) FOR INDIVIDUALS, GROUPS, PRODUCTS, SERVICES OR OTHER ENITITIES, filed Aug. 28, 2009, the entire contents of which are herein incorporated by reference. The present application incorporates herein by reference other prior applications also by the present Inventor: Mark S. DePalma, of 36 Devon Rd., Bronxville, N.Y. 10708, these include all applications titled or related to Systems and Methods for Accumulating Accreditation. These applications, the entire contents of which are incorporated herein by reference are: PCT/US2008/008867 (WO 2009/011925 Pub. Date: 22.01.2009) filed: 21.07.2008, also filed in USPTO on Jan. 19, 2010, Serial No. 12669535, and PCT/US2008/008807 (WO 2009/011916 Pub. Date: 22.01.2009) filed: 18.07.2008.

### TECHNICAL FIELD

The present disclosure relates generally to accreditation and, more specifically, to systems and methods for accumulating and utilizing accreditation and data systems of compensation and supervision for the same.

### BACKGROUND

In recent years, wide scale communication systems and wide area networks such as the Internet have proliferated and become widely adopted in homes, businesses and government. These systems have greatly increased the rapid and facile dissemination, communication and exchange of information regarding products, services, and knowledge generally. However, use of these systems has not been without problems and limitations. Incorrect, unreliable, shoddy and even fraudulent material is often transferred over these systems, without some or all of the readers or recipients of the incorrect or fraudulent information aware that this information is unreliable and unworthy of consideration.

Lack of integrity in the services, products and information that is posted or available in one form or another on the Internet or elsewhere leaves great room for improvement. It would be of the greatest use to attack these problems on a much more universal and root level than the rudimentary feedback systems used on such websites as eBay, as these attempts are merely local efforts to address the “lack of integrity” problem in a very limited and insufficient way. For example, those with bad feedback ratings on eBay can still open accounts on other sites and obtain a “clean slate” with impunity, despite being outright thieves.

Others have developed evaluation or rating systems for persons, products, businesses and/or services (for example U.S. Pat. No. 6,064,978; U.S. Pat. No. 6,434,549; feedback on Linkedin.com, Customer dispute reports on BBBonline, etc.) However, none of these systems can capture, store, process, filter, compile and present evaluations of an entity (e.g., any thing, product, person, group, service and/or activity) across a variety of websites and computer networks and present those evaluations in a organized, intelligent and useful way, analogous to a Dunn & Bradstreet report, not limited to financial information/credit worthiness, but that presents the quality, trustworthiness, and/or accuracy of a product, person, service, entity, group or system. Further, none of the present evaluation systems analyze evaluations and use that analysis to recommend specific types of education or methods of self-improvement. Nor do these types of systems use data or information gathered from such evaluations to coordinate or match persons, groups, entities, products or systems for benefits that become apparent with the disclosure herein.

### SUMMARY

This application describes tools (in the form of methodologies, apparatuses, and systems) for accumulating accreditation. The tools may be embodied in one or more computer programs stored on a computer readable medium or program storage device and/or transmitted in the form of a computer data signal in one or more segments via a computer network or other transmission medium.

A method of accumulating accreditation comprises locating or identifying evaluations from different sources relating to at least one entity, optionally providing evaluation(s) relating to at one entity and accumulating evaluations associated with the at least one entity to create an accreditation associated with the at least one entity.

A method of utilizing accreditation comprises locating or identifying evaluations from different sources relating to at least one entity, optionally providing evaluation (s) relating to at least one entity accumulating evaluations associated with the at least one entity to create an accreditation associated with the at least one entity and using the created accreditation to provide suggested education for the corresponding at least one entity.

As a result of new forms of communication media such as the Internet, worldwide web and new forms of what are called social media, people are responding to and commenting on expressions and activities of other people to a great extent. Internet sites such as Ebay and oDesk allow people to comment upon or Evaluate goods or services that they have received from others. Social media or social interaction sites such as Facebook or Linkedin, allow people to Evaluate or comment upon personal or job related expressions and/or activities of others.

The present inventor teaches in his prior applications that Data or Evaluations regarding individuals or other Entities may be accumulated from various sources, further Evaluation (s) may be performed, and Accreditation(s) formed. The present disclosure teaches forms of social media or interaction that comprise methods and systems of creating and utilizing Evaluation (s) and/or Accreditation(s) including but not limited to data systems of compensation and supervision.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIGS. 1-5 are block diagrams for describing various Cycles or Iterations of Participant Performance according to embodiments of the present disclosure;

FIGS. 6A-6G are flow charts for describing ways of providing Education according to embodiments of the present disclosure;

FIG. 7 is a block diagram showing a computer system capable of implementing aspects of the present disclosure;

FIG. 8 is a block diagram showing a network for explaining various aspects according to embodiments of the present disclosure;

FIG. 9 is a block diagram showing some of the elements forming a system according to an embodiment of the present disclosure;

FIGS. 10 and 11 are block diagrams depicting cycles and iterations according to embodiments of the present disclosure: and

FIGS. 12 and 13 are block diagrams depicting cross-linking according to embodiments of the present disclosure.

FIG. 14 is a block diagram depicting some function of systems of supervision.

FIGS. 15A and 15B are block diagrams depicting systems of compensation.

FIG. 16 is a block diagram depicting incorporation of systems of supervision and compensation with other systems taught.

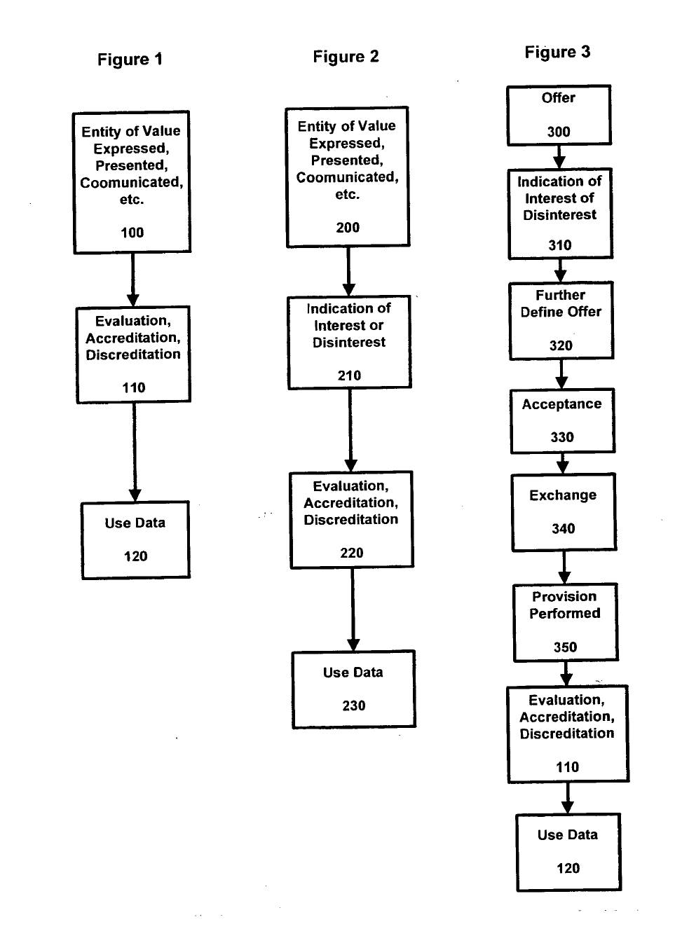

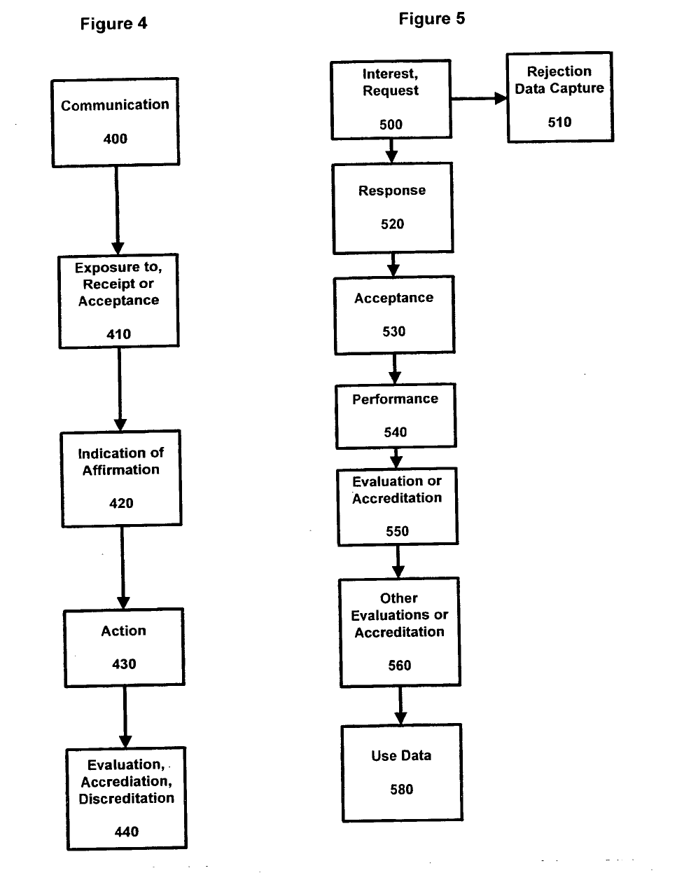

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The following exemplary embodiments are set forth to aid in an understanding of the subject matter of this disclosure, but are not intended, and may not be construed, to limit in any way the claims which follow thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner.

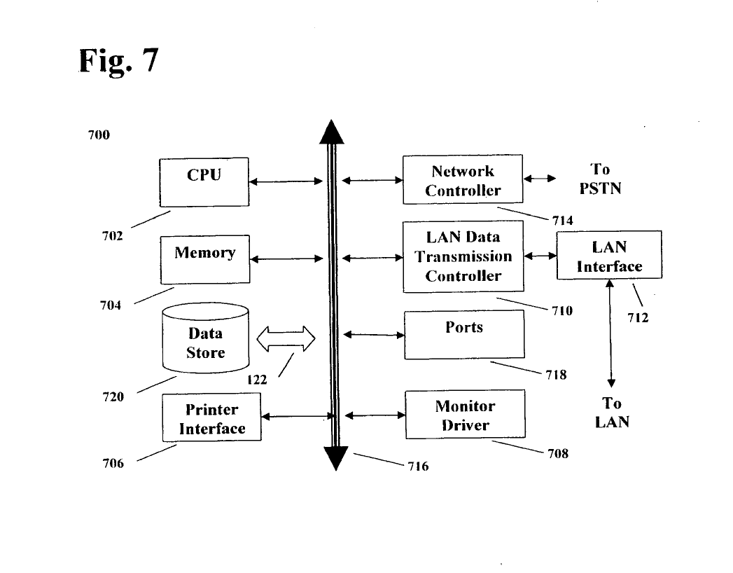

FIG. 7 shows an example of a computer system 700 which may implement various methods and systems of the present disclosure. The systems and methods of the present disclosure may be implemented in the form of one or more software applications running on a computer system, for example, a mainframe, personal computer (PC), handheld computer, server, or cellphone, etc. The software applications may be stored on a recording media locally accessible by one or more computer systems, for example, floppy disk, compact disk, hard disk, etc., or may be remote from the computer systems and accessible via a hard wired or wireless connection to a network, for example, a local area network, or the Internet.

The computer system 700 can include a central processing unit (CPU) 702, program and data storage devices 704, a printer interface 706, a display unit 708, a (LAN) local area network data transmission controller 710, a LAN interface 712, a network controller 714, an internal bus 716, and one or more input devices 718 (for example, a keyboard, mouse etc.). As shown, the system 700 may be connected to a database 720, via a link 722.

The computer system 700 is merely exemplary. The specific embodiments described herein are illustrative, computer system(s) as referred to herein may include(s) individual computers, servers, computing resources, networks, etc., and many variations can be introduced on these embodiments without departing from the spirit of the disclosure or from the scope of the appended claims.

### ****************************GLOSSARY*******************************

### Accreditation

Accreditation includes one or more Evaluations of any type, either positive or negative (e.g., Discreditation) or anywhere in between, which may or may not be Categorized, concerning an Entity. Accreditation may also include one or more Evaluations of any endeavor, product, or Entity of Value created, conducted, performed, designed, expressed, communicated about, used or invented by an Entity, including but not limited to the activities of doctors, lawyers, engineers, chefs, musicians, CEOs, teachers, professors, lawn care specialists, nurses, handymen, plumbers, electricians, maids, talk show hosts, any lay person, amateur, apprentice, hobbyist, etc. Accreditation may result from an Evaluation by a human being or may be generated automatically. Accreditation may also include an Entity's formal education and grade point average, work experience, awards, peer reviews, proficiency ratings from various organizations, military record, licenses, credit rating, credibility rating, feedback ratings from various websites, and any sort of approval ratings. Accreditation may also include ratings, Evaluations or the popularity of tangible products created, invented, designed or produced by an Entity, such as the quality of an Entity of Value, widgets, crops, goods, clothing, devices, food, music, methods, ideas, views or implements, etc.

Accreditation may include or in an alternative embodiment be solely comprised of any Data or information regarding, related to, or specific to any Entity or Entity of Value.

Accreditation may contain or be information or Data that has not been categorized or rated. For example, there may be Data (e.g., a cookie) indicating that a Participant or Entity has visited a particular website. This Data may include, for example, a number of times a site was visited, particular topic areas visited, etc. For any reason this may not have been Categorized or rated or may be Categorized and or rated in the future.

The term Accreditation as used herein may also mean Cumulative Accreditation or that it comprises Cumulative Accreditation.

Categorize/Categorization:

A method of classifying any subject, such as including but not limited to: alphabetically, by number, keyword, phrase, multiple words or subject, any combination of these or using any other way or established method of categorizing information.

Cross Linking:

Associating Entities for combining resources for the same, similar, or complementary purposes, including but not limited to notifying or having Entities that work for or potentially work separately or in communication with each other, in a collaborative, supportive or complementary manner or towards a common purpose.

For example, Cross Linking can be used by Chefs who are experts in different cuisines each do a separate video which is Accredited to them. Other Chefs or Restauranteurs, for example, may use these Accreditations or the Data or Entities located through them for cross linking to create new cuisines or for other uses.

Cumulative Accreditation:

The accumulation of Accreditation, or a running Accreditation. Cumulative Accreditation or Accreditation may be stored in or accessed from or through any type of data structure, including but not limited to a database, file, cookie, file, applet, or both and can be made available either automatically or upon election or registration of the Entity to whom the Cumulative Accreditation belongs or (an)other Entity(ies).

Data Capture or Capture:

Any data or information concerning an Entity that is located, stored, accessed or made accessible directly or indirectly for facilitating access to data such as but not limited to storing addresses of where it is located or information leading to its location. Data may include, but is not limited to, articles or speeches, cases, trials, experiments, operations, peer reviews, proficiency reports/evaluations, and biographical information, Accreditations from other rating systems such as a feedback rating from eBay or a Dunn & Bradstreet credit rating, or student evaluations of a professor. In effect, Data may any form of human expression, etc. Data may also be Captured on any data or information processed (e.g., Evaluated and/or used for formulating, Preparing or determining Education, etc.) or unprocessed for purposes as taught herein by the present disclosure.

Education:

Any data or information which may inform or suggest to an Entity how to improve, expand, or diversify skills, expertise, knowledge, repertoire, or available information. This may include but is not limited to any type of formal or informal training, coursework, course of study, treatise or learning, lessons, tutoring, or any other type of exercise or program. Education may or may not result in a degree, certificate, or any other formal mechanism of recognition, and may include online coursework, programmed learning or software concerning a specific area, endeavor, topic, language, vocation or discipline. The term Education may also include any form of Intellectual Input that an Entity is exposed to or receives. If Evaluated for assimilation or mastery of any Intellectual Input or Education, an Entity may receive Accreditation for Education. The term Education may also be meant to include the receipt of Accreditation for it. For example if it is said that an Entity received Education, this may mean that they also received Accreditation for it.

Entity(ies):

Any thing, Entity of Value, product, person, group, service, system, institution, artificial intelligence, machine and/or activity, etc.

Entity(ies) of Value:

Any tangible or intangible, action, activity, expression, service, information, knowledge or thing created, Provided, Received, perceived or used by an Entity that is capable of being Evaluated in any way. The Evaluation of an Entity of Value may contribute to Accreditation, of any Provider(s), Recipient(s) or Participant(s), engaged with it. An Entity of Value may be Intellectual Output itself of any source.

An Entity of Value can be Intellectual Output itself or Intellectual Output can be Captured related to any Participant relation, communication, or action related to that Entity of Value.

An Entity of Value can be anything that is presented, communicated about or exchanged, even if it is intangible, such as Intellectual Output itself, Performance, etc. For example if a Patent Lawyer is presenting someone's idea to anyone, that idea (Intellectual Output) is being used as an Entity of Value. The lawyer may also be delivering his own Intellectual Output in the way he/she presents that idea and adds ideas of his/her own.

Evaluation(s):

The identification, categorization, classification, rating or measurement of the nature, type, constitution, fact(s), detail(s), aspect(s) integrity and/or quality of any Entity. For example, Intellectual Output, Intellectual Capital, Intellectual Input, Education, Entities of Value and/or Performances may be Evaluated, each in a number of different ways. Evaluations can be positive, negative, neutral, or based on any devised or recognizable system, such as including but not limited to, a point system, words, or letter grade system.

An Evaluation may include or be merely an identification of any interest, familiarity with, or exposure to a given Entity of Value, subject, subject area, or subject category. The nature of a Participant and thus their Evaluation may be provided or established solely by indication (or any Data of that indication) of visiting a particular website, webpage or medium of communication such as a publication or exposure to anything else.

An Evaluation may comprise or be solely, any Data or information that may be used to identify the nature or detail(s) or indicate what the nature or detail(s) may be of any Entity. Any Evaluation may be further Evaluated.

Intellectual Capital:

The IQ, education, experience, knowledge, information base, skill(s) or skill set(s), expertise, repertoire(s), intellectual abilities, proficiency, and/or understanding of an Entity. Intellectual Capital also includes the receipt, exposure, mastery and/or assimilation of Education.

Intellectual Input:

Any contribution or improvement to Intellectual Capital. For example, a unit of knowledge, no matter how trivial or insignificant, for example, learning a single fact from a blog entry, word or gesture is Intellectual Input.

Intellectual Output:

Any expression, action, performance service, presentation, demonstration, indication, or communication by an Entity.

Intellectual Capital regarding an Entity or Participant may be identified from, indicated by or directly expressed by, Intellectual Output (or found through further engagement of or communication of or with, the Participant related to the Intellectual Output). This Intellectual Capital may be used for Evaluation.

Intellectual Output may be Evaluated in various other ways. For example but not limited to, if an Entity is performing a particular laboratory procedure or another type of action, Data may be Captured on this and Evaluation and/or Accreditation may take place. This Accreditation may be used for Cross Linking or Education to help that Participant improve that procedure. Thus there may be no interest in Evaluating the Intellectual Capital of that Participant but his/her Intellectual Output may be Evaluated for other reasons and benefits.

Intellectual Output can be any indication of any recognition or familiarity with, any Entity of Value and may be added to a Participant's Evaluation as a form of identification of the nature of the Participant. In an embodiment, for purposes of comprehensively Capturing data that may reveal something about the nature of any person, group, entity, etc. Evaluation or Accreditation may comprise any Data Captured regarding a person, etc. which may or may not be found to contain any Intellectual Output upon which Evaluations may be based.

Whenever an Entity of Value is Provided by, Received, or exposed to an Entity, Intellectual Output may be related to, associated with or derived by further communication with the Provider, Recipient, or Entity or derived from the Entity of Value itself.

Participant:

Any Entity of which or whom or related to which or whom, Data may be Captured or used for the purposes taught by the present disclosure. A Participant may be aware that Data is being Captured or have an understanding of or active interest in engaging in the purposes taught herein (an active Participant). Or a Participant may be unaware or have acted independently or with no interest of any Data Capture or uses taught herein that may have occurred, occurs or will occur, of or related to such Participant (a passive Participant). Therefore the term Participant means that the Participant may be either active or passive or both, unless specified otherwise.

A Participant may be an Entity that engages in any role or performs any function or process as taught herein. For example a Participant may be but is not limited to, a recipient or provider of Intellectual Output, Intellectual Input, or any Entity(ies) of Value, one that Evaluates, an Educator or formulator or selector of Education, etc.

A Participant or Entity may be in full or in part an auto Participant system, or Entity that may perform any function(s) of a Participant or Entity automatically, such as for example but not limited to smart machines, systems or apparatuses (including but not limited to software and/or hardware) capable of analysis and/or communication, a computer or computers or other data processing system(s), or intelligent system(s) such as a Robot.

A Participant or Entity may include, for example, any type of organization or group such as but not limited to: a corporation or group of them such as a conglomerate, (a) web group(s), public group(s), etc.

Performance:

Any measure of the quality, or how or the manner in which Intellectual Output is delivered or provided. For example, the Intellectual Output of an Entity may be of a very high quality, but the delivery of that Intellectual Output may be very poor, such as a boring lecture, a treatise that is difficult to comprehend or use, or book that is delivered late to a publisher, or an uninspiring concert. This may be referred to as the Performance of Intellectual Output or Performance.

The term Performance as used herein may also refer to the expression, presentation, communication, communication about, providing, transfer, production, delivery, receipt, or exposure to and/or the manner and/or method (some of which will be described below) of the expression, presentation, communication, communication about, providing, transfer, production, delivery, receipt, or exposure to (of) Intellectual Output or (of) any Entity of Value (and may include the substance or material of these) or engaging in Intellectual Input or Education by any Entity.

For example, Performance can occur by (an) Entity(ies) of Value being expressed, presented, communicated, communicated about, transferred, demonstrated, produced received, exposed, delivered, or Provided, to (by) any Entity.

Provider, Provide:

Any Entity, that provides, communicates, communicates about, presents, or transfers (or may do any of these things, Prospective Provider) any type of Intellectual Output or Entity(ies) of Value, or anything else.

Recipient, Receive:

Any Entity that receives or may receive (Prospective Recipient) or, is exposed to Intellectual Output, Input or any Entities of value, or anything else.

### ***********Addendum to Glossary**********

(These definitions also pertain to the section herein entitled, SUPERVISION and COMPENSATION)

Audit: an examination which may include verification and analysis of Data Captured concerning an Entity or an Evaluator and/or examination of the substance and processes of an Evaluation.

Compensation, Compensated: Payment, award, or exchange or transfer of any valuable such as including but not limited to System credits (which may be used to pay for, utilization of the System or (a) part(s) thereof or, services or products performed or provided by other Participants of the System(s) taught in the present disclosure or any disclosure(s) incorporated by reference) or financial monetary currenc(y)ies or credit(s) used by other institiutions.

Evaluation: any definition from prior references. This term may also include Education in appropriate context.

Evaluator: one who Evaluates and/or in appropriate context, Provides Education, Intellectual Input, or selection or guiding of Education.

Educator: one who Provides Education, Intellectual Input, or selection or guiding of Education.

Education: any definition from prior references. This term may also include the, formulation, selection or guiding of Education or Providing of any Intellectual Input.

Supervisor, Supervision: A separate class of Evaluators or Auditors. A Supervisor is one who does not Receive direct Compensation from one or those Entities or Evaluators or Educators which he/she Evaluates or Audits, in that his/her Compensation is more restricted as a rule than non-Supervisor Evaluators' Compensation. Relative to a non-Supervisor, the amount or terms of a Supervisor's Compensation may not be or is as a rule less, directly determined by anyone subject to his/her Supervision. In an embodiment, this may be effected by means of the determination of amount or terms of a Supervisors Compensation being accepted, denied, determined or regulated by an independent third party Entity, other than the Entity (ies) that is receiving or subject to the Supervision being Compensated for.

System: any means, method, media, apparatus(es), machine(s) or device(s) taught herein, within the present disclosure or in any prior application(s) or disclosure(s), incorporated by reference herein.

### ******End of Glossary***************************

Human society is largely dependent on the exchange of goods, services, and with the advent of the modern communication systems, information itself. The Internet in particular has allowed Entities to search for and present, communicate, transfer, and exchange information, know-how, services and products on a scale that was heretofore unimaginable. However, the ease of communication enabled by the Internet also fosters the proliferation of incorrect or unreliable information, untrustworthy individuals, and incompetent businesses. In other words, interactions or transactions that are now easy to accomplish by virtue of the Internet are hampered by the lack of information about those involved, including the intellect, education, experience, reliability, credibility, and/or productivity of the Entity providing the information, product, service or system of interest, for example.

The systems and methods described herein captures, performs, stores, filters, categorizes and presents Evaluations of, Performances of, Intellectual Output, Intellectual Input, Education of Entities and/or Evaluations of Entities of Value. By accumulating these Evaluations (Cumulative Evaluation) and thereby building Accreditation (Cumulative Accreditation), a previously unknown level of trust and confidence can be built for Entities by widely disseminating Accreditation. This dissemination of Accreditation for Entities thereby facilitates transactions and exchanges among those that have never interacted before. The Accreditation can also be improved, corrected (in the case of negative Evaluations or Accreditation) or built upon by recommending Education to an Entity, so the Entity can remain competitive in a particular marketplace for products or services, for example.

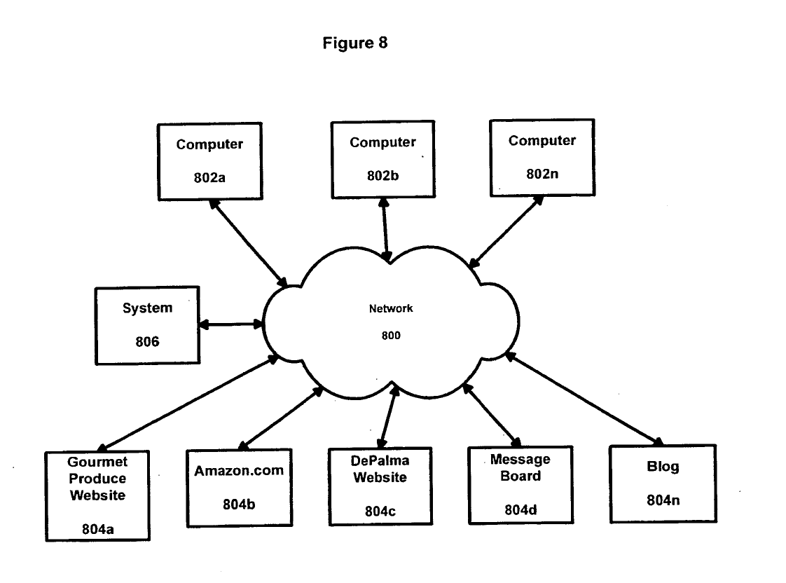

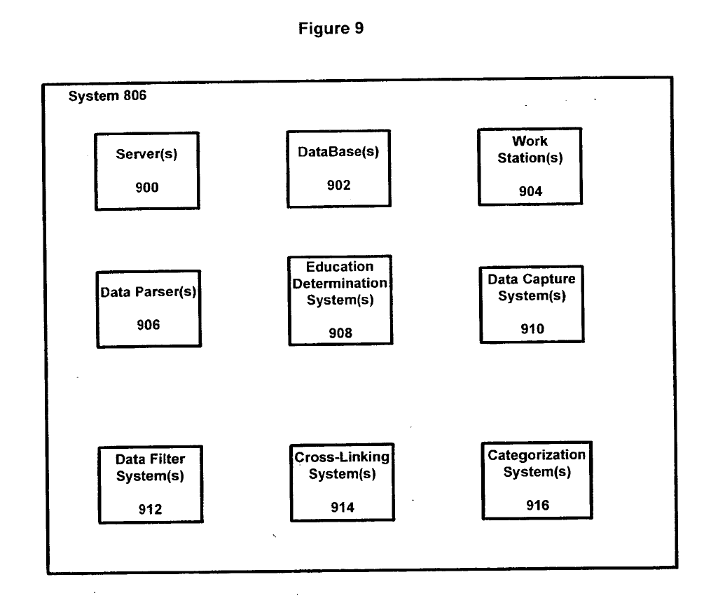

FIG. 8 is a block diagram for describing various aspects of the present disclosure. A network 800 such as, for example, the Internet allows communication using many different types of machines, including various types of computers, servers, etc. Users (802a-802n) of the Internet have access to a virtual endless supply of information. Examples of the types of information sources (804a-804n) include innumerable websites, blogsites, business sites, etc. The range of topics associated with these information sources is immense. Only a few of the types of information sources available are discussed herein. Of course, the present disclosure is in no way intended to be limited to such sources. System 806 represents a system capable of implementing aspects of the present disclosure. As shown in FIG. 9, system 806 may include one or more servers 900, one or more databases 902, one or more workstations 904, one or more Data parsing systems 906, one or more Education determining systems 908, one or more Data Capture systems 910, one or more Data Filter systems 912, one or more Cross-Linking systems 914 and one or more Categorizing, Evaluation, and/or Accreditation systems, 916, etc. Of course, the elements forming System 806 may be in one location or may be spread out over multiple locations.

Now, by way of example, over the course of 10 years, an organic farmer by the name of Jonas DePalma has developed a unique, hyponically grown organic tomato that takes substantially less time and therefore less energy to grow, yet it tastes better than almost all other organic tomatoes. According to this example, Mr. DePalma has recognized the many benefits associated with aspects of the present disclosure and has become an active Participant in the present systems and methods. For example, Mr. DePalma has actively registered with system 806, providing sufficient information to allow system 806 to easily Capture Data associated with him. Mr. DePalma has provided system 806 with the names he utilizes on various websites he visits and/or on which he is actively involved. Mr. DePalma has also agreed that system 806 may examine cookies on his computer to determine any other sites he may have visited. Mr. DePalma has also downloaded software onto his computer(s) that is capable of keeping track of sites visited, the subject matter of the portions of the sites visited, etc. and providing that information to system 806.

The DePalma Tomato is an Entity of Value that represents, in part, Mr. DePalma's Intellectual Capital. Based on the taste, consistency and flavor, Jonas DePalma has received 832 Evaluations for the DePalma Tomato, on a website 804a dedicated to gourmet produce. These Evaluations were subject to Data Capture and contribute to Jonas DePalma's Accreditation, categorized as Entities of Value, DePalma Tomato. For example, Mr. DePalma supplied the name of this site and his name used thereon, when he registered with the system 806. System 806 periodically goes to website 804a and retrieves the Evaluations as Data Capture, filters, categorizes and stores the information.

Jonas DePalma also authored a book on growing hyponic, organic produce entitled, “The DePalma Method For Organic, Consistent Yields.” Mr. DePalma's book is thereofore an example of his Intellectual Output. Mr. DePalma's book has received 29 positive Evaluations on Amazon.com (804b), mostly from farmers and gardeners who tried his method for growing organic tomatos with great success. These Evaluations are subject to Data Capture and also contribute to Mr. DePalma's Accreditation, Categorized as Intellectual Output, Sub-Category, Books & Articles. For example, system 806 periodically goes to the Amazon.com site to see what books have recently been published and to review the evaluations associated therewith. In this case, system 806 has been able to match the book with Mr. DePalma and has Data Captured this information including the Evaluations.

Mr. DePalma has his own website (804c) where he provides biographical information about himself, information about his farm, and where he discusses the technology and methods he uses to grow produce. For example, Mr. DePalma's website explains that he received a Doctorate in Agricultural Science from the University of Maryland in 1985, which is a portion of Mr. DePalma's Intellectual Capital. This information is also subject to Data Capture and becomes part of Mr. DePalma's Accreditation, Categorized as Education; Sub-Category, Formal Education.

Mr. DePalma does business with a number of speciality food shops and high-end restaurants within several hundred miles of his farm. Mr. DePalma's customers usually specify how many pounds of tomatos Mr. DePalma is to deliver, and over what period of time. Because Mr. DePalma has engineered precise controls on yield and crop readiness, Mr. DePalma almost always delivers his tomatos to his customers in a timely fashion. Therefore, on several message boards (804d) that supermarket and restaurant produce buyers frequent, Mr. DePalma consistently receives high marks (i.e., Evaluations for Performance). These high marks are subject to Data Capture and become part of Mr. DePalma's Accreditation, Categorized as Performance, Sub-Category, Timeliness.

Finally, two studies are published during the course of several months concerning lycopene, a naturally occurring organic compound found in tomatoes. The first study confirms that lyopene is a powerful antioxident and that individuals who ingest at least 4 to 5 tomatoes a day experience significantly lower rates of certains types of cancer. The second study discloses that if tomatoes are grown using a particular method, the resulting tomatoes have twice the amount of lycopene as most other types of tomatoes. Education Determining system 908 of System 806 has determined from Mr. DePalma's Accreditation thus far, that these studies could be of interest to Mr. DePalma.

These studies are subject to Data Capture and are referred to Mr. DePalma as suggested Education to improve the lycopene levels (and therefore the antioxident properties) of the DePalma Tomato. These studies are also Intellectual Input for Mr. DePalma. After reading these studies, Mr. DePalma decides to post them on his website and begin growing DePalma Tomatoes according to the method disclosed in the second study (i.e. DePalma Tomatoes now become high lycopene DePalma Tomatoes), which Mr. DePalma also discloses on his website. This information is also subject to Data Capture and added to Mr. DePalma's Accreditation as Education; Sub-Category, Self-Study.

As a result of Mr. DePalma's Accreditation, a new restauranteur decides to place an order for 100 lbs of DePalma Tomatoes, even though he has never met Mr. DePalma and never done business with him before, and even though he has never tasted a DePalma Tomato. Hence, the system and method described herein has, inter alia: (1) encouraged Mr. DePalma to increase his Education concerning how to raise tomatoes; (2) increased Mr. DePalma's Accreditation concerning the raising of tomatoes; (3) increased the quality of the DePalma Tomato by increasing its antioxidant content, and (4) facilitated a transaction among total strangers based on specific Categories of Evaluations that appear in Mr. DePalma's Accreditation (such as the taste of the DePalma Tomato and Mr. DePalma's ability to consistently deliver them on time).

In short, any Entity can be Evaluated, Categorized and accumulated for the purposes of Accreditation. In addition, any Entity of Value can be Evaluated. For example, evaluations may be provided for a make and model of automobile, computer, or any other item or Entity of Value. Evaluations may also be provided for a Performance, such as the delivery of goods by a merchant properly packed and in a timely fashion, the Performance of a musician at a concert, the Performance of a professor in giving a lecture, the Performance of a surgeon for a particular type of procedure, or the Performance of a litigator at Trial, etc.

It will be appreciated that there are various ways System 806 can perform Data Capture as described herein. For example, instead of registered users of System 806 providing a list of sites they frequent, the websites themselves might have a subscription to System 806. When a Participant (active or inactive) visits the subscribed website, the website may (or may not) inform the Participant that information on the site is subject to Data Capture. Data may also be Captured for any Participant or Entity of Value by use of an identifier (e.g., a cookie) that may accompany any Data related to a Participant or Entity of Value. For example, the Participant's computer can include a cookie that is automatically sent to a site along with any Data related to the Participant or Entity of Value instructing that the Data be sent to System 806 as Data Capture. In addition, it will be appreciated from the present description that data may be Captured utilizing any type of device or system including, for example, smart software, cookies, crawlers, robots etc. or other system(s) which crawl or search a network or any location or system. The crawlers, robots, etc. are capable of continually searching a network for information including information relating to a Participant and then performing Data Capture and forwarding the Data to System 806.

Intellectual Output may also be Evaluated, for example, the content of a book, lecture, CD or software. Intellectual Input, Intellectual Capital and Education can also be evaluated, for example, a blog entry, as Intellectual Input, can be Evaluated. Similarly, the Intellectual Capital of an Entity can be Evaluated, for example, the extent that a particular individual is an expert in a particular field, or the extent a Corporation has technical expertise in a particular field, such as GPS, Radar Receivers, or Digital Imaging. These Evaluations are Captured, processed or filtered, and may be Categorized and accumulated to become the Accreditation associated with the Entity.

In order to assist Entities to improve, or to improve their Entities of Value, Accreditation or Evaluations can be analyzed to recommend Education or Intellectual Input. For example, this Education may be in the form of an online course, a degree program, one or more books or articles concerning recent developments in a Category of Accreditation, or an educational dvd or videotape. Similarly, Intellectual Input can also be recommended. For example, if an Entity has Evaluations concerning vintage Japanese turntables, a blog entry or webpage comparing several vintage Japanese turntables can be referred to that Entity. Or, if an Entity such as law firm has a negative evaluation concerning their billing practices, corrective action such as a course in acceptable/equitable billing practices could be recommended to the law firm. In sum, recommended Education may expand, improve, correct and/or diversify any product, service, entity, activity or system. Further, subsequent Evaluations may show that the corrective Education either did or did not have its intended effect. For example, if the Evaluations of a law firm's billing practices went positive after several key billing partners took a course on billing practices, those Evaluations might demonstrate that the law firm assimilated the prescriptive Education.

Among other things, Education can also be Evaluated. Anyone or anything that provides Education can be evaluated, such as those who provide formal Education, such as Universities, to instructional books, videotapes, DVDs and computer software for learning a foreign language, for example. Separately, the content of a course can be evaluated, in other words the Intellectual Output of the course, or the Performance of the instructor can be Evaluated. The Evaluations can become part of the Accreditation of a University, a University Professor, an instructional software program, an aerobics instructor, or any person, institution, organization, software or book, etc. that provides Education in any form.

Those who have Accreditation in a particular field or endeavor can be referred to others who are similarly Accredited to exchange ideas and suggest joint endeavors. This is an example of Cross-Linking. Similarly, those who are in need of a particular type of expert can search for those particular categories of Accreditation to locate an Entity that can assist them in solving a specific type of problem. Or those in search of a particular type of Entity of Value can search for those who, grow or produce them in a geographic area or in a price point, or of a certain size, color, quality or flavor. This ability to locate or associate is termed Cross-Linking. As discussed above, Cross-Linking can automatically associate other Entities of interest, or can result from a search of Accreditations.

Accordingly, the system and method described herein facilitates the exchange of information, know-how, experience as well as goods and services by providing a rating, measurement, and/or identification system that categorizes and discloses the background, education, experience, reliability and trustworthiness of an Entity. The system and method also fosters Entities to improve themselves or their products by recommending Education to improve Accreditation, or simply providing feedback on an Entity of Value, Intellectual Output, Intellectual Input, or Education associated with an Entity.

More detailed aspects of the present disclosure will be described below.

Participant(s), including people (or increasingly, even machines or systems implemented by humans), engage from day to day in the presentation, communication, transfer, or exchange of Entities of Value such as, for example information, knowledge, products, services, etc. These interactions or presentations carry or can carry or be associated with great amounts of information about the Participant(s) involved. For example, it can include the information and knowledge resources, as well as skill sets and abilities, reliability, credibility, productivity, etc., of the Participants of these communications, transfers and exchanges, most of which has not been utilized for utmost benefits prior to the present disclosure. This information or data, as described to some extent herein, can be referred to as Intellectual Capital. The delivery of this data and information by the Participants, can be referred to as the Intellectual Output, and the manner and way of delivery along with any Entity(ies) of Value delivered or received, can be referred to as the Performance of the Participants.

Capturing and processing Data and Information on this Intellectual Capital, Intellectual Output and Performance of the Participant(s) and using it for purposes such as Evaluation, Accreditation and Education, improved matching of recipients to providers and various other benefits, some of which were touched upon above, will be described in more detail later below.

Data or information may be Captured or acquired on such Intellectual Capital, Intellectual Output, Entity(ies) of Value and Performance(s) of Participants and processed according to the teachings of the present disclosure utilizing any system(s) of data processing (which may be capable of filtering and/or processing data or information for the uses taught by the present disclosure) and/or data storage and retrieval, such as (a) computer system(s). Data for Capture may be acquired through any type of communication between humans or Participants or between humans or Participants and machines or systems utilized by them. Such communication may include but is not limited to cell phones, keyboards, or any other type of textual or language input video, audio terminals, fax machines, other computers, transducers, audio microphone, graphic or text scanner, audio or graphic language and word recognition systems, video, video recognition system(s), or any type of human or Participant recognition, mediation, translation, interpretation or intervention, which may be expression or action over graphic, visual, audio or other sensory communicative or detection devices, systems or media, or over any system of communication etc. Data or information processed according to the present disclosure such as Evaluations, Accreditations and Education may be also communicated over such systems or devices, or any other methods of communication such as including but not limited to bill boards, or other graphic media, audio or video media, printed media, television or networks of communication such as including but not limited to the Internet or Worldwide Web, phone systems etc.

Whenever knowledge, information, product(s), service, etc. or any other type of Entities of Value is/are expressed, communicated or communicated about, transferred, presented or exchanged, information is carried with it or may be carried with it regarding the Intellectual Capital (defined herein as resources, knowledge base, etc.) of the Participant(s), which may be of (a) Provider(s) and/or (a) Recipient(s) or prospective of either. This may be in the form of direct Intellectual Output, which may be for example a direct expression or communication of the Participant, or it may be for example an action or Data or information related to the Participant from which (if necessary with further communication or Data Capture) Intellectual Output may be recognized, interpreted or translated.

When tangible or intangible products, information, knowledge, service or any other type of Entity of Value is presented, communicated, communicated about, indicated, expressed, exchanged, etc. by any Participant, there is an indication that such Participant (either a Provider and/or Recipient, of such Entity of Value, data or information), has a familiarity with this product or Entity of Value. This indication itself is Intellectual Output which may be added to the Evaluation (s) and/or Accreditation(s) of such Provider or Recipient. The Provider may also supply information along with the product or via further communication regarding the product, revealing more about their role in the provision of the product, design, manufacturing, etc. This may be Captured as Intellectual Output and the information on the Provider is Intellectual Capital of the Provider. A Recipient may engage in communication or expression regarding or related to this Entity of Value which may also provide Intellectual Output of the recipient. This information or Data can be acquired or Captured (stored, filtered, processed, etc.) through any method of communication, data processing and/or storage such as, for example, those described above, and may be used for Evaluation or Accreditation, as well as other purposes such as Education and matching of recipients to providers and Cross-Linking.

Many products come with or contain information or knowledge about that product which may provide Intellectual Output and a measure of the Intellectual Output of the Provider. For example, a food product may contain a list of Ingredients or nutrients and if this product is transferred or presented to another Participant, it provides (and if necessary with further communication with the Provider) Intellectual Output that the Provider has familiarity with and knowledge of.

A provider of products with various types of warranties (which may be in textual form or any other form acquirable or Capturable by the System), may make presentations, transfers, exchange(s) etc. to other Participant(s). This provider may have engaged in Intellectual Output of the use of Warranties and exhibited some degree of familiarity with the use of warranties. The specific Intellectual Capital that provider has about the use of Warranties may be clear or may obtained thru further communication with him. For example, he may know or have the ability to valuably opine and inform on what types of warranties are best for what type of product(s). This Data may be captured according to an embodiment of the present disclosure. The Data may then be Evaluated so that the Provider may be Accredited or Discredited on the Intellectual Output of information on Warranties or other types of legal informational Entities of Value (such as but not limited to what distribution agreements work best with certain types of products, information that may go beyond or complement the Intellectual Capital of many traditionally Educated and Accredited experts such as lawyers, MBAs, accountants, etc., of which the present disclosure may also complement and improve the value of their services) or any other types of Entities of Value that he participates in the exchange, presentation of or communication about, etc.

Many other products may be considered legal Entites of Value such as for example but not limited to paper or electronic financial Entity(ies) of Value, such as including but not limited to, instruments such as bonds, securities, or deeds. These may also be considered informational Entities of Value.

Many other products or services are based to a large extent on the informational or knowledge content thereof and may be termed Informational Entities of Value. Such a category or categories may include but is not limited to: Research Reports, weather reports, satellite data or other types of instrument or human generated data or information, books or other types of written material or lectures or simple single word or single phrase answers or questions or statements or gestures. Such material may be presented or transferred in audio or video or graphic form or any manner in which Data may be Captured.

When a Provider presents such Entities of Value or a Recipient receives them, such Participant is demonstrating an indication of Intellectual Output of having or lacking (a conclusion on this depending upon the results of Evaluation, Accreditation or Discreditation) a familiarity or skill set or informational knowledge base (Intellectual Capital) in the classification(s) or category(ies) of such Entities of Value.

Intellectual Output regarding the presentation or communication of any Entity of Value may be Captured. For example being the Provider or Recipient of plumbing or a plumbing service or lawn care or expressing an interest in these (or any accompanying facts, data or details) demonstrates some awareness of or familiarity with such Entities of value which in and of itself can be considered Intellectual Output of the Provider and/or Recipient. Any further communications of Provider or Recipient or any privy Participant may be Captured as Intellectual Output and added to the Evaluation or Accreditation of any such Participant. This may seem trivial by itself but when added to the Evaluation or Accreditation of an individual it may help in matching with others (e.g., Cross-Linking) or Educating in ways taught by the present disclosure to provide many benefits. For example, a Recipient of lawn care services may be able to share information with others that lack Accreditation in certain areas. For example, a Recipient in lawn care that has received Evaluation and Accreditation in safe, non-toxic or organic methods of weed control may be matched with others that have Accreditation in lawn care but lack Accreditation in such safe, non-toxic or organic methods of weed control. This may benefit all those involved in the exchange of valuable information.

Whenever information or knowledge is presented or service performed or any Entity(ies) of Value expressed by or about, or otherwise arise, Intellectual Output may be detected and/or processed according to embodiments of the present disclosure. Such Entity(ies) of Value or expression(s) by or about them or Intellectual Output itself (such as a direct expression of knowledge or information) may be simply an utterance in natural language that is recognizable by another Participant, Auto Participant or Apparatus of the present disclosure, an answer with an affirmative or a negative, a yes or a no or the question itself, which may be a single word, phrase or sentence or in the form of an elaborate Request for a proposal to do a project, any kind of expression which may be unsolicited, gratuitous, or in response to any other expression(s) of any Participant(s). The Intellectual Output may be entire courses given on material, (which may be received as Intellectual Input and Evaluated in a manner as described herein), a degree program, or a single gesture (meaning of which may be somehow Captured as information of Intellectual Output such as by human or machine or system recognition, translation, and/or mediation), a physical, visual and/or audible performance or demonstration, many volumes of writings, etc.

As described herein, an Entity of Value can be Intellectual Output itself and may be used to build Accreditation and provide income for a Participant or Entity. For example, a businessman or lawyer with no formal training in business (such as an MBA, accounting degree, etc.) can, over a period of time, offer various information on business (which may include marketing, financing, sales advice, etc.) in any media or venue such as blogs, websites, printed articles, etc. and even engage in business transactions such as on Ebay. Eventually by building up Accreditation in giving business advice (Intellectual Output used as an Entity of value) such as in Cycles and Iterations to be described later below, he or his Entity (a corporation for instance) can command or be offered compensation or exchange for business advice although he had no formal training but was Accredited only through the Accreditation in accordance with aspects of the present disclosure.

As a non-limiting example, (a) Participant(s) may Provide (express, present, exchange, transfer, etc.) or communicate or express about or something related to a tomato, a computer, a car or any other item or Entity(ies) of Value. The Participant(s) may make a gesture regarding the tomato or other item, which may be Captured by the System as indicating that the tomato may have been produced without exposure to synthetic pesticides (or some other factor or criteria of Intellectual Capital, knowledge or information about the tomato, such as but not limited to, for example, nutritional value of the tomato). This gesture may be identified as Intellectual Output of the Provider by the System and then utilized for purposes of the present disclosure such as Evaluation (s) (was the information correct, appropriate, timely given, etc.), Accreditation(s) of the Provider(s), etc. If the Recipient(s) play a role where they engage in some form of Intellectual Output as identified by the System, they may be Evaluated and/or Accredited also. Data Capture of any of these processes may help in the many benefits provided by the present disclosure.

Intellectual Output regarding the tomato Provider may be Captured and processed by the System from any number of types of presentation(s) or exchanges, expression(s), etc. of Entity(ies) of Value. For example, the Provider may engage in the packaging and shipping of tomatoes, or teach a course on tomatoes, or write a book on tomatoes, or grow tomatoes, give a lecture on tomatoes, engage in conversation about tomatoes, answer (a) question(s) about tomatoes, or raise (a) question(s) about a tomato or tomatoes, etc. Information or Data of Intellectual Output may be Captured from any of these types of presentations, exchanges, communications, transfers, etc. of Entit(ies) of Value, and used for Evaluation (s) and/or Accreditation(s) of any Provider(s), Recipient(s) or other Participant(s) and/or used for any other purpose described in the present disclosure.

Whenever any Entity(ies) of Value are presented, communicated, transferred, exchanged, or conveyed from one Participant to another (either of which may be actual or prospective), a manner(s), type(s), and/or method(s) of Performance(s) are involved. Various Iterations or Cycles of Performance which are common and quite useful for the purposes of the present disclosure will be described later below. These manners and methods of Performance can reveal Intellectual Output on the parts of either or both Recipient(s) and Provider(s). For example, if a Recipient demonstrates interest (by selecting web pages, web forums or websites or individual selections therein, or by providing compensation or exchange of other Entities of Value, etc.) in certain classes, sub-classes or categories of Entities of Value (which may contain Intellectual Output or indications thereof of Provider(s)), then the Recipient(s) is indicating Intellectual preference(s) and/or selectivity(ies) for certain classes, categories or sub-classes of Intellectual Output or Capital. This is a form of Intellectual Output of the Recipient. The Recipient may also engage in repeated exchanges with Providers in which Intellectual Output may be provided by all parties.

Once Data is Captured that bears information or an indication of Intellectual Output, Evaluation (s) may be performed on that Intellectual Output or prospective Intellectual Output to further identify and process that information. From the results of that Evaluation (s), Accreditation and/or Discreditation may result in one or various or many classes, sub-classes or categories of Intellectual Output or Input. Cumulative Data may be maintained, tracked, located and/or relocated on one or numerous Evaluation (s) data Accreditation, and/or Discreditation in various or single categories, classes, subclasses or subject areas of Intellectual Output for each Participant.

Accreditation(s) and/or Discreditation(s), as well as Evaluation (s) may be in the form of a single or Compilation(s) and or Computation(s) of Result(s) of Evaluation (s), from one or any number or any combination of classes or categories upon which the Evaluation (s) are based. These Accreditations, Discreditations, or Cumulative Accreditations and/or Discreditations, may be made available to Participants in any Part or procedure of the present disclosure, such as Iteration(s) or Cycle(s) of Performance or demonstration of Intellectual Output, determination of Intellectual Input, Education, etc. by any Participants, or the System itself, as will be described in more detail later below.

Evaluation and Accreditation can be compiled, computed or otherwise processed, based on Data or information, related to the specific history of a Participant, regardless of where it comes from. This is analogous to the way commonly known financial information services, such as Dunn and Bradstreet use methods of data capture, where financial information is gathered or accumulated based on any financial information or transactions related to the subject or participant of those transactions or data, regardless of the source.

### Evaluations

Intellectual Output, Intellectual Input, Intellectual Capital, Education, Entities of Value and Performances may provide (an) Evaluation (s), be Evaluated or further Evaluated, Categorized and added to Accreditation. Furthermore, the ability to assimilate Education or Intellectual Input may be Evaluated. Evaluations may also be subject to Data Capture, or may be generated automatically, manually or otherwise through human intervention (as the term manually, is meant to convey throughout this disclosure), for example, by human beings writing a review for an Entity of Value, for example, a service performed by an entity such as a law firm, physician or hospital, or a species of Education.

It will be appreciated from the present disclosure that an Evaluator may be Accredited or discredited based upon their Evaluation and those Evaluators of the Evaluator may also be Accredited on their evaluation of the Evaluator, and so on and so forth thus providing an endless stream of checks and balances.

Evaluations themselves can be expressed in many different ways. For example, the detailed rating system found on websites such as eBay might be sufficient for simple transactions, but may not be suitable for rating Education or a Performance. Evaluations can use letter grades, words, language, alphabetical ratings, numerical ratings (such as 10 out of 10), stars, marks, strikes, simple thumbs up or thumbs down, or any method devised to evaluate or rate something, someone, a service or the performance of a single task or series of tasks. Factors such as quality, integrity, accuracy, correctness, comprehensiveness, taste, color, shape, sound quality, speed, finesse, efficiency, thoroughness, truthfulness, honesty, timeliness, or any other factor can be a component of an Evaluation or an Evaluation by itself.

An Entity of Value may be a product of the Intellectual Capital of any Provider of it. Therefore an Evaluation of the Entity of Value may contribute to the Intellectual Capital or Output Accreditation of the Provider. A Recipient of course may also engage in Intellectual Output (communication, expressions, etc.) regarding an Entity of Value, and receive Accreditation for it.

For example, the DePalma Tomato can be Evaluated for size, color, shape, taste, lycopene level, potassium level, shelf life, usefulness for tomato sauce, and a myriad of other factors. Similarly, Mr. DePalma can be Evaluated on his books, articles, blog entries, and his Performance, including Mr. DePalma's ability to deliver DePalma Tomatoes in a timely fashion. Evaluations can also concern the quality of a inquiry about the DePalma Tomato, or Mr. DePalma's answer to that inquiry.

Accreditation may be Categorized in any number of ways. For example, Evaluation (s) and/or Accreditation can be Categorized using any type of numerical or alphabetical system, for example, such as but not limited to the Dewey Decimal System, the Patent Manual of Classification, any similar type of system(s) or any other system for classifying subject matter. Accreditation may also be found through computer methods such as but not limited to keyword, word string, or Boolean searches. Further, a single Evaluation may fit in more than one Category or Sub-Category. Using the above example regarding Jonas DePalma, Mr. DePalma's book may cover topics such as organic farming and hydroponic farming. Accordingly, Mr. DePalma's Accreditation may contain Evaluations regarding each of these Sub-Categories under the general Category, Intellectual Output, Sub-Category, Books and Articles, Sub-Sub-Category: Organic Farming, and second Sub-Sub-Category: Hydroponic Farming. Further, each of these Sub-Sub-Categories may include scores or grades for accuracy, efficiency, ease of use, etc.

Referring to the previous example, if Jonas DePalma posts answers to questions about organic farming on www.organicfarmingreview.org (a mythical website were organic farmers exchange information and methods), those answers could be subject to Data Capture and Evaluated for accuracy, efficiency, cost, conformity to USDA Organic regulations, etc. Mr. DePalma's posts would then be Categorized and added to his Accreditation in a number of different ways. For example, Mr. DePalma's posts might be Evaluated, those Evaluations Captured and then Categorized by topic such as pest control, optimum nitrogen levels, or organic tomato incubation techniques and incorporated into Mr. DePalma's Accreditation. Alternatively, Mr. DePalma's posts could each be Evaluated, Categorized and incorporated into Mr. DePalma's Accreditation individually.

As a result, Mr. DePalma's Accreditation may have many different sources and therefore will present a more accurate and fuller picture of his agricultural business, his Education, the depth of his practical knowledge/experience (based on, among other things, the number of Sub-Categories in his Accreditation regarding organic farming and his Evaluations) and his customer approval ratings, which are also a component of his Accreditation. This in-depth and varied portrait of Mr. DePalma set forth in his Accreditation in turn facilitates others to do business with Mr. DePalma by providing a level of trust and confidence among those who have never met one and other and who have never done business with each other.

Negative Evaluations, which may lead to Discreditation, are valuable in their own right as they perform several functions. For example, one or more negative Evaluations may result in a suggested, corrective Education or Intellectual Input to improve the taste, marketing, delivery or nutritional value of one's organic tomatoes, for example. Negative Evaluations may also be valuable simply as feedback concerning any number of issues that permit the person, entity or system to change and adapt to improve in a myriad of ways and better serve a particular customer base, attract new business, or improve one's trustworthiness, reliability, or any type of Evaluation. For example, negative Evaluations may cause a particular entity to improve the reliability of their products (their Entities of Value), their services (their Performance) and the marketing of products and services (another Category of Performance).

### Accreditation

Accreditation is an accumulation, filtering and/or Categorization of Evaluations that may be compiled over the course of days, months or years (which is Cumulative Accreditation), or Accreditation may contain a single Evaluation. Accreditation may summarize and Categorize Evaluations to provide a quick overview, and/or may also provide access to the Evaluations themselves, in the event a reader or system may wish to see the exact content of a particular Evaluation or the contents of a number of Evaluations. Evaluations may also be linked to the Intellectual Output, Entity of Value, Performance or the person, product, service, entity or system being Evaluated to provide the reader with context or additional information about the person, product, service, etc., or to recommendation specific types of Education (or Intellectual Input)

It will be appreciated that Evaluation (s) and/or Accreditation(s) may contain information or Data that has not been categorized or rated. For example, there may be information or Data that a Participant or Entity has visited eBay. Although this Data may be unrated and uncategorized Data, it does to some extent “identify the nature” of that Participant or Entity. This information or Data may be further analyzed at some point to show that the particular section of eBay that the Participant or Entity visited is devoted to a particular subject category of Entities of Value and therefore the Participant or Entity has shown some familiarity with or exposure to that category.

Accreditation may contain in whole or in part common Data or information which may include Categorization(s) and/or rating(s) related to any Entity, from Performance to Performance which may include but is not limited to: to Iteration, to venue, to communication forum, to media or type of media, regarding any type of Entity of Value, or category or type of Intellectual Output, Input, Education or for any other purposes taught by the present disclosure.

Evaluation (s) or Accreditation(s) for any Entity may be obtained from network based Entities whose primary function is to operate over the Internet such as including but not limited to: Amazon.com which may offer literary, music or other types of ratings, Ebay which may offer customer feedback or evaluations, Question and Answer websites which may give ratings. Of course Data may be Captured from any network based source and used for Evaluation according to the teachings of the present disclosure.

Evaluation (s) or Accreditation(s) for any Entity may be obtained from sources outside of the Internet or Worldwide Web or from non-network based Entities. Such non-network or non-web Entities would be any whose primary function is non-network or that could or did exist independently of the Internet such as including but not limited to: traditional institutions of formal Education, Colleges, experts or authorities, various professional oversite or licensing organizations, literary reviews or critics of various types of endeavors, organizations that provide awards such as the Nobel prize or Pulitzer prize, etc. Any of these may offer ratings and/or categorizations of Intellectual Output or Entities of Value. Of course Data may be Captured from any network or non-network based source and used for Evaluation according to the teachings of the present disclosure, whether or not they provide ratings and/or categorizations or are considered authorities or experts.

Accreditation may also be used to match Recipient to Provider or Provider to recipient either through manual or human intervention or automatically. This may be considered a type of Cross Linking, but is a special benefit since Cross Linking allows matching of Provider to Provider and Recipient to Recipient for engaging in same, similar or complementary efforts.

### Education

Evaluations and/or Accreditation can also be used as a feedback mechanism to recommend further Intellectual Input and/or Education to foster improvement in the thing, product, person, Entity, service or system that was Evaluated. Note that Intellectual Input and/or Education can be recommended without negative or neutral Evaluations, to broaden or improve a person, thing, product, service, Entity, activity or system. Based on Evaluations or Accreditation, Intellectual Input or Education may be customized, formulated, designed and selected to improve, expand, or diversify Education and thereby, the Intellectual Capital of any a person, thing, product, service, Entity, activity or system to better serve his/her/their/its own interests or that of others.

Intellectual Input may consist of any type of knowledge or information, no matter how small or trivial. For example, Intellectual Input may be, for example, a single word in response to a query such as how do you say “Good idea” in Japanese. Intellectual Input also includes message board or blog entries, DVDs, articles, books, videos, demonstrations, and/or courses. Education may be in the form (but not limited to) lessons, tutoring, or other types of exercises or programs. Education can be used for corrective purposes or to provide complementary information or skills based on prior Evaluations or Accreditation as a whole. Education may also be used to diversify or teach skills that are different from past Evaluations, and/or Accreditation.

A person, service, Entity or system may be Evaluated after receiving Intellectual Input or Education, based on the person, service, Entity or system's mastery, assimilation, understanding, and proficiency in the Intellectual Input or Education. In addition, the person, Entity, service or system providing the Education can be Evaluated based on the content of the Education and its delivery (i.e., its Performance).

The Intellectual Output from one person or Entity, for example, may provide Intellectual Input or Education to another person or Entity. Moreover, a person or entity may select and provide his or her own Intellectual Input or Education through self-study, which may then be Evaluated (for assimilation and mastery of that material or subject matter). As a result, any person, Entity or system can improve its own Accreditation by self Education.

Although Intellectual Input or Education can be derived from any source, Intellectual Input or Education may be custom-tailored to the needs or benefit of any one holding Accreditation.

For example, if a microbiologist, Dr. DeCampo is working on cultivating a certain strain of bacterium known as Eschericia Coli or E. Coli and is trying to find what culture medium is best to grow E. Coli, a search might reveal several articles on this topic. The microbiologist could then study these articles (Intellectual Input). Later, using the principles taught in the articles, Dr. DeCampo succeeds in growing stains of E. Coli that were very difficult to grow. Later that year, Dr. DeCampo publishes his findings in a scientific journal, to much acclaim. These praises are subject to Data Capture and added to Dr. DeCampo's Accreditation as, among other things, mastery of the above-mentioned scientific articles. Separately, Dr. DeCampo could rate the authors of articles in question for content, clarity, ease of use and accuracy, providing Evaluations to other microbiologists. These evaluations could be Captured and added to the Accreditation of these other microbiologists.

Formulation, Selection, Design, Choice, and/or otherwise Determination of Intellectual Input or Education and Process of Education

Based upon any Performance(s) or Data Captured by any Part(s), Sub-Part(s), Step(s), Sub-Step(s), Action(s), or Data acquired otherwise by the System, including but not limited to Evaluation (s) and/or Accreditation(s), Intellectual Input used for Education or Instruction (which in an embodiment may include correction), may be formulated, selected, designed, chosen, or otherwise determined, to inform or suggest to any Participant(s), how he/she/they may improve, expand, or diversify skills, expertise, repertoire, knowledge, or available information in any way to better serve his/her/their own interest(s) or that of others in the future.

Education may be any form of any Intellectual Input offered, exposed to, or given to any Participant(s), that may be helpful, and it may be in the form of any Intellectual Output from any other Participant(s). For example, Education may be (but is not limited to) in the form of one or more words or gestures, one or more sentences, visual or other sensory perceptible communication, or an article(s), book(s), video(s), demonstration(s), course(s) or an entire degree program. It may be in the form (but not limited to) lessons, tutoring, or other types of exercises or programs. In some embodiment(s) it may be to correct Participant(s) Output, in another or others, to inform or teach complementary information or skills from that demonstrated and/or Evaluated and/or Accredited in the prior history of any Participant(s). Education may also be used to diversify or teach skills or information that are different from a Participant(s) past history, skill(s), prior Evaluation (s), and/or Accreditation(s) or cumulative Accreditation(s).

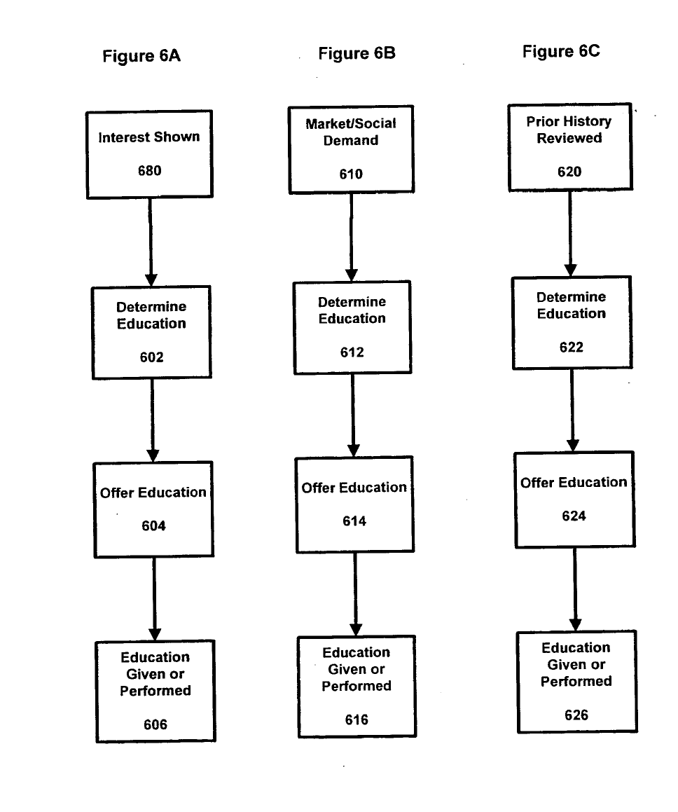

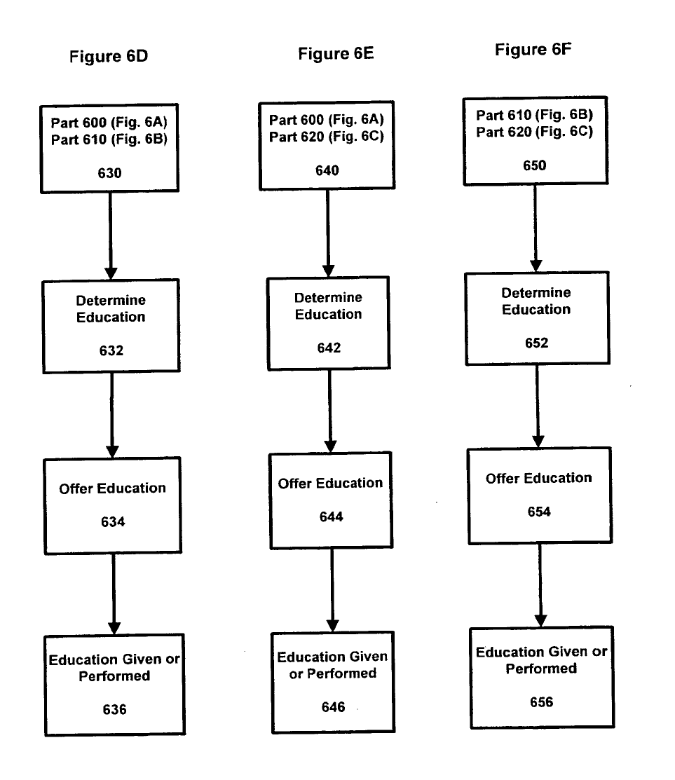

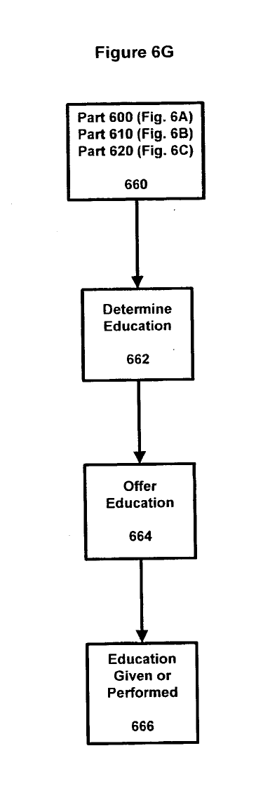

FIG. 6 illustrates non-limiting exemplary ways in which Intellectual Input or Education may be formulated, selected, designed, chosen, or otherwise determined for any Participant(s).

For example, as illustrated by FIG. 6A, if there is any type of interest shown (Part 600) (or demonstration or presentation, etc. of any type) by (a) Participant(s) for Intellectual Output, or Entity(ies) of Value (that may convey any type or types of Intellectual Output), this Data may be captured and Education may be determined accordingly (Part 602) and offered to any Entity(ies) (Part 604). The Education may then be provided or offered to (an)other Entities(y) based at least in part on that Data Capture and/or Accreditations of those (that) Participant(s) upon whom the Data is Captured regarding the interest shown. (Part 606). Accordingly, in this embodiment, Education may be formulated based at least in part on Data Capture or information of interest shown of Participant(s) other than the or those to whom the Education is offered. Such interest may be (but is not limited to) indicated or measured by Questions asked and/or answered on web sites, at web forums, or Output offered unsolicited on web sites or blogs or in news groups, or in any announcements, presentations or communications. Such interest may be based upon or lead to Cross Linking of Participants. This interest may be Captured (and may be Evaluated and/or Accredited), from any Performance, including but not limited to Cycles or Iterations of Performance described in the present disclosure. The interest (which may include a degree or volume of demonstration of interest from Participant(s)) or demonstration in a particular type of Intellectual Output or subject, category, or area of interest may come from Provider(s), Recipient(s), Seeker(s), etc, and Education may be used for any other Participant(s), to improve, expand, inform, or otherwise better, complement, or diversify (which may include diverging from) their knowledge, understanding, or proficiency with regard to that type of Intellectual Output, subject area, etc.

FIG. 6B illustrates that Market or social Demand or need or interest, which may not be measured by the volume or degree of Intellectual Output associated with it (such as in determining interest as in FIG. 6A), but instead is something which is in need or demand or of interest, which people for some reason or another may not be familiar with or be prepared enough or have Intellectual Capital enough to demonstrate Intellectual Output of or not want to, may be used to determine or formulate, etc. Intellectual Input and Education. In this case, when a Market or social Demand is determined and Data Captured (Part 610), appropriate education can be determined (Part 612). The Education can then be offered (Part 614) to the Participant(s) and given or performed (Part 616). For example (but not limited to), there may be a great need for Strontium or a rare earth metal, and although few people may have Intellectual Capital associated with the provision of such an Entity of Value, high compensation (and thus high need or demand) or high value of Exchange (which may be from a single or very few episodes or incidences of Performance, or from information imported or acquired from outside the System) may be detected from Performances such as in the Cycles or Iterations of Performance(s) of Exchange of Entity(ies) of Value and Intellectual Output, described in the present disclosure or from information imported or acquired by the System from outside source(s). Thus a high market or social demand may be used to formulate, determine, select, etc., Intellectual Input or Education offered or given in the prospecting, mining, processing, or acquiring, etc. of Strontium or the rare earth metal. This example differs from that of 6A, in that in this embodiment, the degree of compensation or exchange or type of compensation or exchange or reward, offered, paid, transferred or demonstrated, can be utilized to measure and identify the need for Education rather that the degree or volume of interest shown or demonstrated by Performance or Intellectual Output.

FIG. 6C illustrates that a Participant(s) prior history, Evaluation (s) or Accreditation(s) (which may include Performance in which the Participant is currently engaged), which may include Data or Information Captured, regarding the Participant(s) prior Performance, Intellectual Output, or Education, which may include any familiarity with any Entity(ies) of Value, including Cycle(s) or Iteration(s) of Performance participated in, or Performance related to, may be reviewed (Part 620) and used to select, formulate, determine, etc, Education (Part 622). The Education may then be offered to the Participant(s) (Part 624) and the Education can be given or performed (Part 626).

FIGS. 6D thru 6G show that any combination's of the above criteria and data Capture may be used for formulating, selecting, etc. Education. FIGS. 6D thru 6G are described in more detail below.

### Networking and Data Capture

Given its record keeping and data processing function, Accreditation should preferably be accessible, portable and follow the person, entity, service or system being Accredited, much like a financial or credit rating of a particular person or business.

Accreditation may be stored in a database, link, cookie, file structure, pointer (to a database, website or storage device), or any other hardware or software that can store data representing the Accreditation or a particular person, Entity, institution or system, or associated with a particular Entity of Value, quickly and efficiently, similar to how financial records are checked before a person opens a store credit card on the spot, or how a person's credit limit associated with a particular credit card is located and provided quickly to a merchant before the merchant decides to accept the credit card.

A variety of systems and methods to store and retrieve data representing Evaluations or Accreditation are well known in the art. For example, data representing Accreditation may be stored in many forms such as (including but not limited to) magnetic media such as magnetic tape or disks, optical media such as disks or CDs, electronic devices such as RAM or ROM, etc.

In this regard, aspects of the present disclosure may comprises a discrete database or databases and/or facilitated ways of access to discrete Data (such as storing of locations or information on how to access Data) on any information relevant to Data Capture or Evaluation and Accreditation as well as other processes of the present disclosure such as, for example, Education for any Participant or Entity, etc.

On a wide area network or the Internet, a cookie, identifier or similar mechanism may facilitate the Capturing of Data (e.g., Intellectual Output, Performances, Entities of Value) associated or created by a person, service, entity or system being Evaluated or Accredited. In this way, the activities, blog entries, books, articles and/or advice of that person or entity, and Evaluations of a person or entities' activities, blog entries, books, articles and/or advice for example, can be Captured, filtered, Categorized and stored for integration with that person's Accreditation autonomously. The Accreditation Data can be stored on a centralized website backed by a server farm, or any similar storage facility known in the art. For privacy concerns associated with individuals, for example, a consent or subscription agreement may be provided so that the person or entity in question understands that his activities on the Internet will be monitored and Evaluations added to his or her Accreditation.

Furthermore, individuals, entities or systems, for example, may want to have Evaluations of their Intellectual Output, Performances or Entities of Value added to their Accreditation. This can be accomplished by manually adding information, such as a link for example, that points to these Evaluations, or some other mechanism of manually providing Evaluations to be incorporated into an Accreditation can be provided. Further, a webcrawler or software application can be employed to automatically locate the activities of an Entity, such as books, articles, blog entries written by the entity, Entities of Value created, grown or manufactured by the entity, or Performances by the entity, so that these items can be subject to Data Capture and added to an entities' Accreditation.

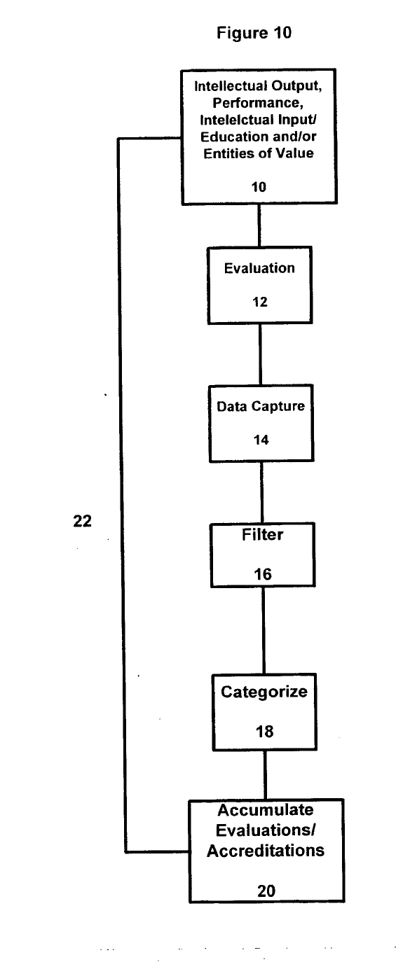

Referring to FIG. 10, Step 10 lists examples of the different modalities or things that can be subject to an Evaluation (Intellectual Output, Performance, Intellectual Input, Education, and/or Entities of Value) or in and of themselves may constitute and Evaluation. For example, the content of a book (Intellectual Output), the quality of a lecture (Performance), the content of an informative blog entry (Intellectual Input), the content of a software program that teaches Japanese to English speakers (Education) or a new strain of rice (an Entity of Value) may be Evaluated as in Step 12, or constitute an Evaluation. Each of these things or actions are subject to an Evaluation or further Evaluation, which may be Captured by the system (note Data Capture can occur at any point in this flow diagram) in Step 14. The system may then filter the results of the Data Capture for relevance, recentness, or the Accreditation of the Evaluator, for example, as shown in Step 16. The Evaluation is then Categorized in Step 18 according to what has been Evaluated (e.g., Intellectual Output, Performance, Intellectual Input, Education, and/or Entities of Value), and then incorporated into Accreditation in Step 20. As shown in Step 22, the entire process can be and often is repeated as a series of cycles, leading to an Accumulation of Evaulations.

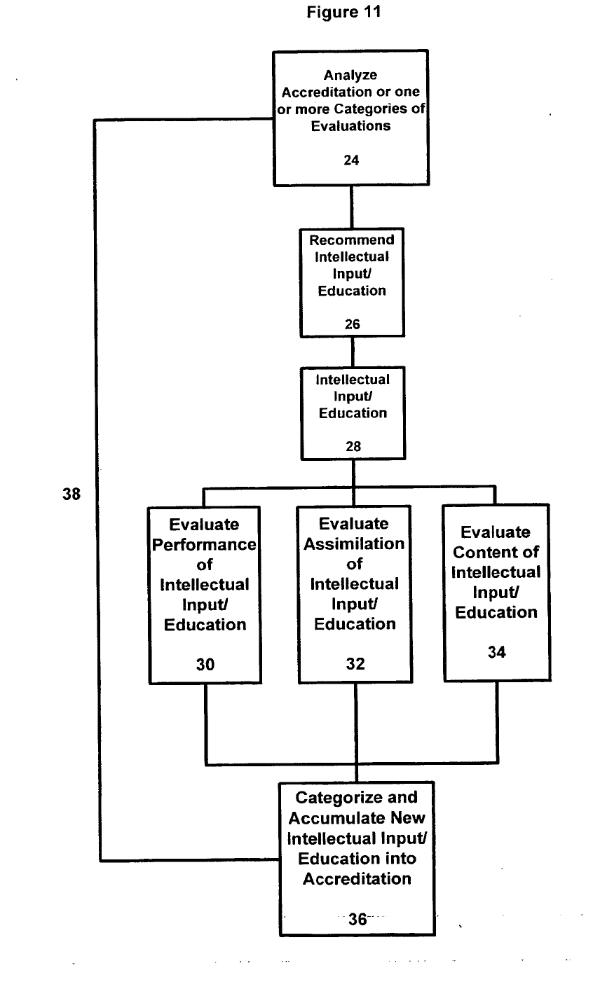

Referring to FIG. 11, Accreditation or one or more categories of Evaluations are analyzed in Step 24. Evaluations and/or Categories of Evaluations, as well as Education are noted, analyzed and compared to other persons, entities or systems with similar Evaluations, for example. Education or Intellectual Input is then recommended in Step 26. The Education or Intellectual Input recommendation is pursued in Step 28. The person, entity, institution or system may then Evaluate the Performance of the Education/Intellectual Input in Step 30 and/or may Evaluate the content of the Education/Intellectual Input in Step 34, for example. Separately for example, other persons, entities, institutions or systems, may Evaluate the assimilation or mastery of the Education/Intellectual Input (Step 28) in Step 32. One or more of the Evaluations of Steps 30, 32 and/or 34 are then Categorized and incorporated into Accreditation in Step 36. Step 38 indicates that this process may be repeated indefinitely.

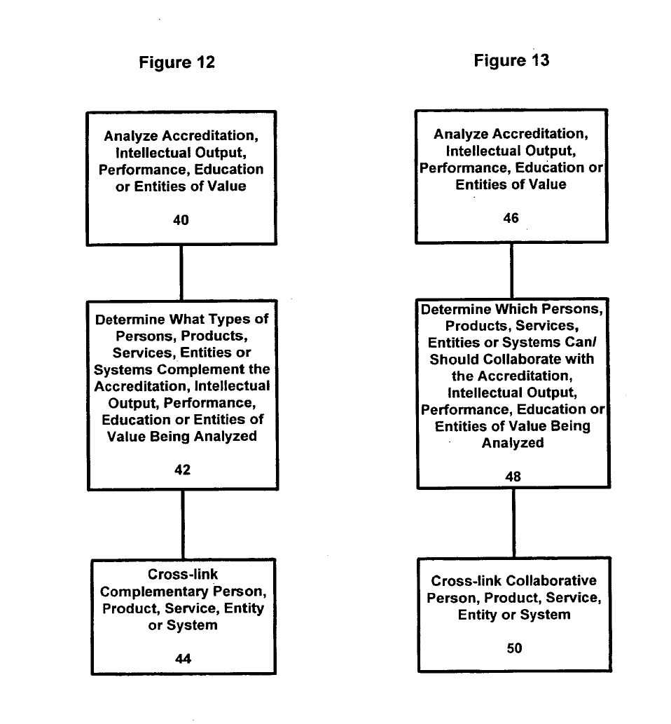

Referring to FIG. 12, Accreditation, Intellectual Output, Performance, Education/Intellectual Input or Entities of Value are analyzed in Step 40. A determination is then made concerning what may complement or be of interest to the person, entity, institution or system being analyzed in Step 42. Finally, a complementary person, product, service or entity, or system, for example, is presented by way of a link, banner ad, email, postal mailing or any form of communication, in Step 44. “Complementary” is used in this paragraph to mean that a person, product, service, entity or system is recommended as something that will compliment the Education, Evaluations and/or Accreditation of the person or thing being analyzed.

Referring to FIG. 13, Accreditation, Intellectual Output, Performance, Education/Intellectual Input or Entities of Value are analyzed in Step 46. A determination is then made concerning what person, product, entity, institution or system might best collaborate with the person or thing being analyzed in Step 48. Finally, in Step 50, a person, product, entity, institution or system that might best collaborate with the person or thing being analyzed is recommended in Step 50. The recommendation referenced in Step 50 may be accomplished using any form of communication, including but not limited to a link, a banner ad, an email message, a text message, a phone call or a mailing.

An identifier specific to each prospective or actual Participant or Entity can be like a social security number (or fingerprint identification) to prevent people from using false identities, as well as for tracking data of the Entity's or Participant's with accurate identification of the source.

It will be appreciated that any type of the communication(s), Data, information, or indications of the present disclosure may be in natural language or made by indications on a display, or by machine, apparatus, device, or any language thereof such as including but not limited to software, digital, etc.

### Supervision and Compensation

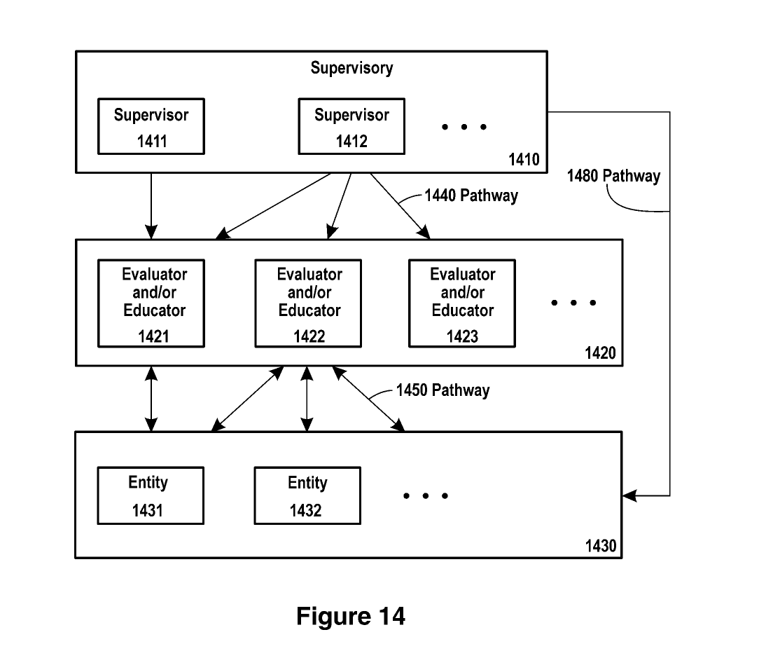

A System may be formed and implemented (including but not limited to being incorporated in any social media or social interaction website, internet or other data or communication system location, or distributed data or network system) comprising method(s) wherein Evaluators or Educators may Evaluate and/or mentor, Provide, select, or guide Intellectual Input or Education of any Participants or Enitites. Evaluators may be Compensated for Evaluation (s) such as by financial currency(ies) or other means. FIG. 14 attached, illustrates a method in which this may be done. Other ways and means or methods may also be performed according to the present disclosure. As Illustrated by FIG. 14, section 1420, any number of Evaluator(s) (as depicted by Parts 1421-1423) may Evaluate or further Evaluate Data or prior Evaluation (s) of any number of Enitities(y) (as depicted by Parts 1431-1432 of Section 1430). Any of these Evaluators may receive Compensation from any of these Entities for Evaluating, Accrediting and/or mentoring or selecting or Providing Intellectual Input or Education. A Participant may play the role of either Evaluator or Entity. FIG. 14, Section 1410 illustrates that Evaluator(s) of any Evaluator(s) or Entity(ies) who may be termed Supervisors (any number of whom may exist within (the) System(s) of the present disclosures, as depicted by Parts 1411-1412 . . . ), may Evaluate so that they are not directly Compensated by those whom they Evaluate (as described above). Such Supervisor(s)' Compensation or payment may come from advertising revenues, a general pool of funds from fees or revenues generated (as a per match, listing, subscription or other type of charge) from Evaluators being matched to Entities or Entities being matched to Receivers or consumers or from any other source. Thus such Supervisors would not have or have a limited conflict of interest with their desire for Compensation in objectively Evaluating or Auditing others. Pathway 1440 illustrates that (a) Supervisor(s) may directly Audit or Evaluate (an) Evaluator(s) or (an) Educator(s). Pathway 1480 illustrates that (a) Supervisor(s) may directly Audit or Evaluate (an) Entity(ies). Pathway 1450 illustrates that (a) non-Supervisory Evaluator(s) or Educator(s) may Evaluate (an) Entity(ies) who may also be (an) Evaluator(s).

Such Supervisors may act so as a to curb or check any Compensatory interest that Evaluators may have to unjustifiably promote or favorably or unfavorably Evaluate others or themselves, for personal reasons such as but not limited to receiving Compensation directly or indirectly from or at the expense of those whom they Evaluate. Such Supervisors may be spurred or alerted to engage in Evaluation or Auditing of the actions, Data or Evaluation (s) of others by complaints or flagging by any Participants. This complaining or flagging may especially come from the Receivers of any Products, Services, or Intellectual Output or products or Entities of Value where it is reported that such Entities have acted in a way which may be construed to be deficient of prior Evaluation or Accreditation. Or for example such flagging or complaining may come from any Entity or Entities who engage in competitive activities, and it is suspected that an Entity has been improperly Evaluated or Accredited. Or such flagging or complaint may be entered or for any other reason. Alternatively such Supervisory Evaluations or Auditing may be engaged in by routine or voluntary request from by (an) Evaluator(s) or Entities(y) being Evaluated by such Supervisors, or for any other reason. Thus such Evaluations performed by Supervisors (who are being Compensated in way that is less dependent upon the results of the Evaluation (s) that they perform) provide Evaluation (s) that may be considered independent, free from conflict of interest and add a type of further credibility to the Evaluation (s) they perform and any Accreditation stemming from that(those) Evaluation (s), as compared for example to non-Supervisory Evaluators who are compensated as a rule more directly by those they Evaluate.

Regarding these System(s) or method(s), Compensation or motivation for Evaluation or selection or Providing of Intellectual Input or Education may be comprised any of a variety of factors, means or methods. Over the Internet and through other means of communication, many people engage in various forms of communication or expression regarding the activities, products or services of others for the sake of social networking or maintaining or establishing social connections. For example on sites such as LinkedIn, people offer recommendations of others regarding professional activities. On Facebook people comment on the activities of others. In the case of (a) social media System(s) of the present disclosures or other disclosures of the present Inventor, it may be found for example that a lawyer with experience, know-how, and/or Accreditation in a specific area of law may wish to Evaluate and/or select or Provide Intellectual Input or Education to another lawyer in that specific area of law merely for the sake of establishing or maintaining a social contact or building a social network. This lawyer who provided such Evaluation or selection or Provision of Intellectual Input or Education may benefit by gaining a referral or opportunity to participate in a legal case with the other lawyer or any contact of the same as a result of his Providing such service(s) of Evaluation or Selection or Providing of Intellectual Input or Education for the other lawyer.

However, the present disclosure teaches that Compensation (for example but not limited to financial, or any other goods, services or valuables) may be offered and/or made to a Participant or Entity for Providing Evaluation or selection or Providing of Intellectual Input or Education. This may be done using various methods, some examples of which are given here. Other methods may also be performed in accordance with the teachings of the present and referenced disclosures.

For example, (an) Evaluation (s) and/or selection, preparation, and/or delivery of Education, may be performed for or in conjunction with Compensation which is given, offered or paid by the Entity or representative of the Entity that is being given or offered such Evaluation (s) and/or Education. This compensation may be based upon or issued upon future income or Compensation that the subject Entity of the Evaluation (s) and/or Education, Receives. As per this example, if a professor or graduate student of computer science Evaluates a programmer for some programming work that he does or has done in Cobol (a computer language) and then such programmer does more work in Cobol, the Evaluator may Receive compensation, financial or otherwise, upon or stemming from any Compensation such programmer Receives then or at any time or in the future. Of course the Evaluator may receive compensation before, during or after any Evaluation, Education or other service is performed. The Evaluator may also be Compensated if no further work in Cobol or otherwise is performed or the Compensation may be limited to that stemming from work done in the specific area in which the Evaluation (s) or Education was Received such as in Cobol in this instance, This may for example depend upon terms of agreement between Evaluator or Educator and the Receiving Entity or Evaluator or upon site or System required terms, etc. However, in accordance with what is described elsewhere, if a Supervisor Evaluates or Audits an Evaluator or other Entity he/she would not be permitted to receive Compensation) directly from the Evaluator or Entity that he/she Evaluates or Audits. In an embodiment a Supervisor may act as a non-Supervisory Evaluator or Educator with (an) Entity he does not act as a Supervisor with. Other embodiments to avoid conflict of interest may be clear with the present disclosures.

Many who first begin to use the Systems taught by the present disclosure may not have the resources or want to pay to utilize a System that they are not familiar with. For these reasons and others, a method may comprise having the pool or source(s) of funds from which Supervisors are paid Compensation, enhanced, augmented or made up of revenue generated from future activities of those (Entities, Evaluators, or any other Participants or visitors to the System) who are Evaluated or Provided with selection or delivery of Education or Intellectual Input, Such revenue may be generated as but not limited to, a percentage of fees or revenue paid as a result of or to initiate any work or output of Evaluators or Entities or from any other source (i.e. Sponsoring or advertising revenue, etc.). Again other embodiments may be clear with the present disclosures.

In addition in order to promote objective Evaluation, Evaluators may be required to pay a fee or percentage of income to an account which may be forfeited if they are found to have been dishonest or erroneous in their Evaluation or if the Education that they render is found to be deficient. Evaluators or Educators may also be policed or managed by having rights of use of Systems of the present disclosures curtailed, suspended or restricted.

Using the teachings of the present disclosures, Entities may be matched or connect, Receive or Provide, present, exchange or communicate any Entities of Value, goods, services, or other expressions with more accountability, transparency (when due), and reliablility, precisely aimed towards the needs of individuals and the global marketplace, than ever available on a wide scale before. Any Entities of Value of the present disclosures such as including but not limited to Evaluation, Education, Providing Intellectual Input, Providing Cross Linking, etc. may be conveyed, expressed or exchanged using the present and disclosures using any method(s) of exchange expression or transfer that are known or become apparent to one familiar with the present disclosures and related arts.

However, we present that such Entities of Value and methods taught by the present disclosures such as including but not limited to Evaluation (s), Selection or Providing of Intellectual Input or Education as well of Evaluation of Evaluation (s) may be exchanged using prior known methods of exchange or conveyance of Entities of Value. For example, an Entity may come to a flat fee arrangement with an Evaluator and/or Educator where Compensation terms are offered by the Entity and accepted by the Evaluator or vice versa. As another example an Evaluator may come to a flat fee arrangement with another Evaluator to Evaluate his protocols or work using the same type of process. Again, as discussed above any of these entities of Value such as Evaluation or Education may be paid for or Compensated for, based upon or stemming from future earnings of the Recipient. Any of these Entities of Value may be exchanged or purchased or transferred with Compensation using but not limited to any method of purchase known in the prior art such as price determination stemming from a Request for Proposal or any type e of auction or bidding system for goods or services such as but not limited to Sealed first price auction, a Vickrey Auction or any type of auction that may be reversed in how the parties approach one another or the offer and bid.

There are many novel advantages that the teachings of the present disclosures offer over the prior art when exchanging, negotiating or engaging in the transfer of any Entities of Value. Regarding those Entities of Value discussed above such as Evaluation and Education some of the novel advantages include but are not limited to: An Evaluator or prospective Evaluator (with or without a particular Accreditation) may have information made available to him/her automatically or via manual searching through keyword identification of the prior Accreditation of the Recipient of the Evaluation or the Intellectual Output or other factor of the work to be performed or product to be delivered that may be subject to the Evaluation. The Recipient of Evaluation may also be matched to the Evaluator automatically or through manual search via keywords or classification of work product or Accreditation using the same type of information. Of course an Evaluator's Accreditation could include a listing or details of Entities he/she Evaluated in the past and data on success rates of those Entities. It is clear that the teachings of the present disclosure provide a more precise and novel way for Evaluators and Entities to connect based upon real life expertise and needs, because of the centralized system of Accreditation, than anything else found to this point. For example, one who has written blogs or answered questions on the use and problems of particular types of boilers could be matched with an Evaluator who is a Professor of mechanical Engineering who has Accreditation in the invention, design and implementation of those boilers. The Evaluation could proceed with more accountability on either side of Recipient or Provider of Evaluation and/or Education than has been known in the prior to the present disclosures, based upon data from any standard form of communication media or venue.

Of course the System(s) of the present disclosures may include the transfer, exchange or conveyance of any Entities of Value, goods or services using all the advantages and Systems taught by these disclosures. For example an auction or product or service offering and purchasing system may be utilized such as Ebay or a job board such as elance or oDesk may be utilized, where the advantages of the present disclosures of making available or known to be available centralized Accreditation or centralized Education or Evaluation may be incorporated. Thus when presenting, offering or exchanging or seeking any goods or services or Enitity (ies) of Value over any website or system of communication such as Ebay, craig's List, odesk, phone marketing, cable marketing, etc., at any point of communication or expression, the Accreditaiton, Evaluation, Education, Supervision, Compensation, etc. or any other benefits of the present disclosures may be offered, made available or known to be available. This could include, but not be limited to, where there is communication or expression, specific to any Entity who is a Participant or prospective Participant of the System(s) of the present disclosure or (an) Entity(ies) of Value of which Data may be Captured for use in the System (s) of the present disclosure, over any such websites or systems of communication. Thus the market value of or confidence in any Entity or Entity of Value presented or sought over any of these sites or systems of communication could be increased due to the accountability and transparency in exchanges, communications and expressions that the Systems of the present disclosures provide.

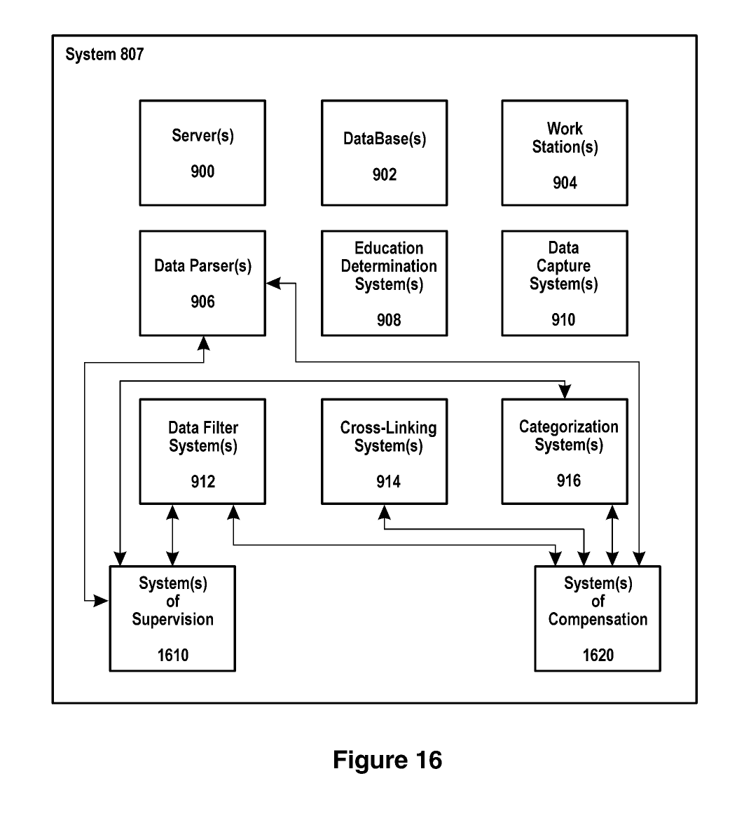

Any of these Systems of the present disclosures (such as for example but not limited to those depicted by (a) System(s) of system 806, FIG. 9 or system 807, FIG. 16) that could be distributed over any network(s) from site to site or system of communication to system of communication also could be used or located within any site(s) or location(s) accessed or located over (a) network(s) dedicated more strictly to the Systems of the present disclosures (for example but not limited to those depicted by (a) System(s) of system 806, FIG. 9 or system 807, FIG. 16) this may include any site, website or communication system location that is specifically used for the System(s) of the present disclosures. The Entitiy(ies) of Value specific to the teachings of the present disclosures such as Evaluation (s), Compensation, Supervision, Education, Intellectual Input, Cross Linking, the offering of any product or service, communication(s) or expression(s) in conjunction with any of these, etc., could be offered, made known, or known to be available either within the Systems of the present disclosures such as including but not limited to system 806 or system 807 or distributed over any sites or system(s) of communication over any network(s). For example any of these benefits could be offered over (a) site(s) or website(s) specific to system 806 or 807 or Systems of the present disclosures, or elsewhere such as including but not limited to many websites, search engines, phone systems or other systems of communication. As referred to above and elsewhere, an Entitiy(ies) of Value specific to the teachings of the present disclosures such as Evaluation (s), Education, Intellectual Input, Cross Linking, the offering of any product or service, communication or expression in conjunction with any of these, etc. could be offered, presented, or exchanged using any of the methods of exchange of Entities of Value or goods and services known to the arts, such as any types of auctions, offer and bid systems, flat fee or price arrangements, requests for proposals, etc., where such offering presentation or exchange may take place either distributed on sites or locations over (a) network or on (a) site(s) (such as including but not limited to a website or websites) or location(s) specific to the System(s) of the present disclosures.

Some systems or sites engage in evaluation of products or services exchanged, provided or performed by people as well as types of supervision over these exchanges or provisions. For example, ebay.com, offers a system of buyer feedback wherein a buyer or recipient of a product may offer an evaluation of the quality of the provision of such product. If there is a dispute between the recipient and provider of a product stemming from a negative evaluation of a product or provision of that product, by the buyer or recipient, Ebay offers a type of supervisory service termed the, “Ebay Resolution Center”. Odesk.com, allows a type of evaluation of work product received by buyers from contractors, termed “feedback”. They also offer a type of supervisory service called, “Dispute Resolution Process”. People who engage in this process and act as a type of supervisor are termed therein, “moderators”. Angieslist.com, offers an evaluation system to recipients of contractor work. If a negative evaluation is lodged by a recipient a dispute process may take place in a type of supervisory system termed, “the Penalty Box”.

The Systems of the present disclosure, differ from and provide novel Systems and advantages over the evaluation and supervisory systems mentioned above, in many ways, but not limited to some of which, we will mention as follows. The Systems of the present disclosure teach that Evaluation (s) may be performed based upon the Performance and substance of product, or service, activity, communication or expression, Intellectual Output, Intellectual Input, Intellectual Capital, Education, etc., presented or offered by (a) Provider(s). The(se) Evaluation (s) may be performed by a third or a plurality of parties other than or in addition to the Recipient(s) (or even if there is no targeted or identified Recipient, such as in an expression, communication or mere presentation or offering of a product, service, work etc. over any network, site or system of communication) of any product, service, activity, communication or expression, Intellectual Output, Intellectual Input, Intellectual Capital, Education, etc., presented or offered by (a) Provider(s). Thus this differs from these other systems of evaluation, such as on ebay.com, angie's list.com, or odesk.com where the evaluation is done by the recipient based upon product or service delivered or offered to a targeted recipient. In addition, the Systems of Evaluation of the present disclosures provide Accreditation or Cumulative Accreditation stemming from any Data Captured of Intellectual Output, Intellectual Capital, Intellectual Input, or Evaluation (s), etc., from site to site, or location to location over a network such as the Internet and/or any system of communication. This may be performed a plurality of times in an iterative process to produce an Accreditation more accurate, accountable and transparent and useful due to organization and access, than any University or other institutional system of Accreditation has been able to provide heretofore. This Accreditation may therefore be used for Education, Cross Linking (the formation of teams), or Intellectual Input (provision of information), more accurately targeted to people's needs than ever before. In addition, the Systems of the present disclosure teach Compensation for such Evaluations, creating a new means of market value and income for any serious, productive and diligent intellectual exchange over any network. The Supervision of the present disclosures is supervision over any of these activities novel to the present disclosures rather than merely over the selling of products or services as touched upon above.

Examples of some aspects and variations of Systems and apparatuses which may be utilized in implementation of the Systems discussed herein (“herein”, used anywhere in the present disclosure(s), means anywhere throughout the present disclosure(s)), follow:

As clear from the present disclosure, Systems are established so that as Data is generated over (a) network(s) or system(s) of communication, related to an Entity or Entity of Value, Data Capture may be performed in real time or later, with accountability. This may be done by identifying and verifiying, that Data was generated and/or the substance of that Data, specifically related to (an) Entity(ies) or Entity(ies) of Value. Optionally Data Capture may occur or Systems of Data Capture may be used, to access data of the specific location of where it was generated, of when it was generated, and/or with the Capture of contextual data. [Mention something of the mechanics of systems of Registration and Subscription] These Systems of Data Capture as depicted as [No.] in systems 806 and 807, may comprise use of (an) identifier(s) which according to the present disclosures may be active or passive. Data Capture, may be performed for example, as discussed in prior disclosures, based upon Systems of Registration or Subscription of either the Entity or Entity of Value or Systems of Registration or Subscription of sites or locations visited such as websites or communication system locations for example phone number locations on a phone network so that information may be automatically to some extent located and/or identified to be specific to a particular Entity or Entity of Value. Identifier apparatus(es) which are useful for such location and/or identification of Entity or Entity of Value specific Data may be either passive or active. A passive identifier may be for example but not limited to a simple data string, which would be specific to an Entity or Entity of Value like a social security number, or a password. This data string identifier could accompany any data that is communicated, generated or presented related to that (or group of) Entity(ies) or Entity(ies) of Value within a location or site in a communication system, over a local network or a wide area network such as the Internet or over a plurality of networks. Multiple passive identifiers could be used for any Entity or Entity of Value. For example, a plurality of data strings of names or passwords used on different sites related to an Entity or Entity of Value could be supplied to Systems of the present disclosures and these could all be utilized to collect or access data on such Entity or Entity of Value. An active identifier may be for example a cookie, a robot, or smart software that can automatically collect, locate or identify data specific to an Entity or Entity of Value or crawl or search a network or any location, system or database(s) to identify and/or locate such data.

Data may be filtered as in Data Filter System(s) 912 for Data of Intellectual Output, Input, or Education or any other criteria of interest in matching Entities for the purposes of the present disclosures. This data may be part of the Accreditation of any Participants in the System or it may be collected or accessed prior to identification and Accreditation having taken place. Data may be parsed or separated using Data Parser 906 for data of particular types of Intellectual Ouput, Intellectual Input, Education etc. related to an Entity or Entity of Value so that the substance of any Intellectual Output, Input, or Education may be compared to that of the parsed or separated data of Intellectual Output, etc. related to another Entity or Entity of Value (or for example from another episode of Data Capture for the same Entity or Entity of Value). This parsing or separation of data for use in comparisons is useful (among other purposes) for matching Supervisor(s) or non-Supervisory Evaluator(s) with (an) Entity(ies or Entit(y) ies of Value that may receive such Supervision or Evaluation (or for Cross Linking or other purposes). Supervisors and non-Supervisory Evaluators for a given Entity or Entity of Value may be selected due to maximum matching of this parsed or separated data between Supervisors or Evaluators and the Entities receiving Supervision or Evaluation. Identification if not done already may be done to identify the Entity to whom the parsed or separated data is related. Thus Supervisor(s) or non Supervisory Evaluators may be matched to Entities to engage in the processes of the Systems of the present disclosures. This same process may also be used to match Entities for Cross linking or team formation where they may work independently or in collaboration on any activity(ies). Both parity and disparity of filtered parsed or separated data may be used to match Entities for Cross Linkig Categorization such as depicted by System(s) [No. in 806 and 807] may be done before or after matching using this(ese) System(s) of parsing, separating, and comparison of Data related to any Entity(ies) or Entity(ies) of Value. For example in an embodiment, Data of Intellectual Ouput, Intellectual Input, Education etc. related to an Entity or Entity of Value may be Categorized based upon subject or for example keyword(s) found in the Intellectual Output, Intellectual Input, Education etc. Then this Categorized Data may be used for matching using the parsed and separated data of (an)other Entity(ies). Again this may be used for example but not limited to the matching of Supervisors or Evaluators to Entity subjects of Supervision or Evaluation.

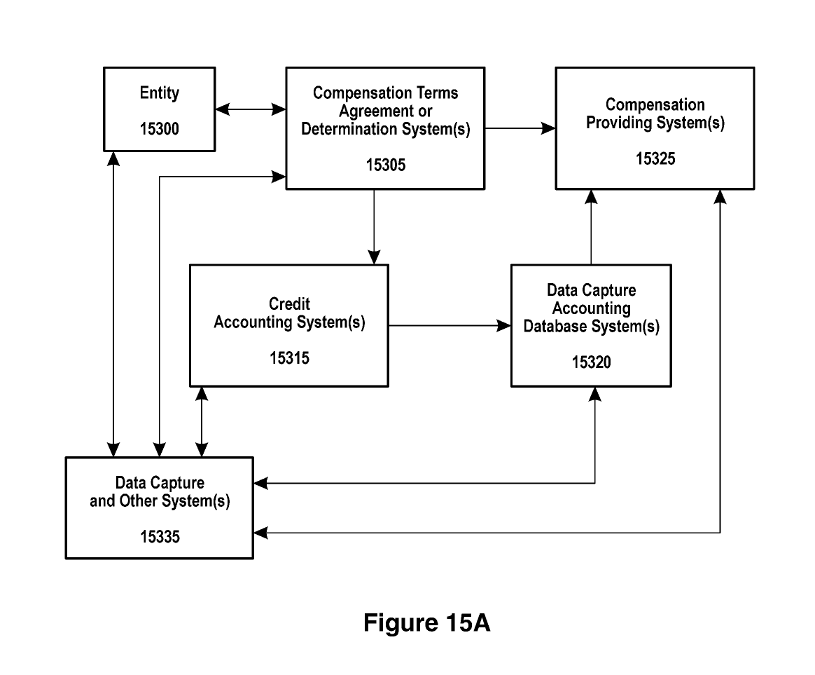

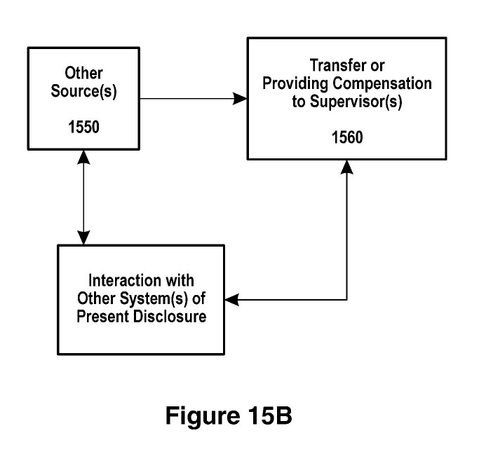

As stated elsewhere Supervisors differ from non-Supervisory Evaluators in the manner of Compensation. System of Compensation is depicted as [No. 1610] in FIG. 16. Some Embodiments of Compensation are depicted in FIG. 15. Any Data Captured by any of the Systems of the present disclosure may be used for matching of Entities for example, Data Captured on Compensation may be used for Entities seeking or requiring Evaluators or Educators in a specific price range. Or with history of price range all of this may be part of Accreditation of Entity and may be used with filtering and data parsing sytems for matching as done above.

Compensation may be performed on a site or sites specifically dedicated to the Systems of the present disclosures or distributed any where over (a) network(s) such as from site to site website to website.

FIG. 15A shows means by which non-Supervisory Evaluators, Educators or those who Provide any Intellectual Input, Cross Linked Entities, or those who Provide by engaging in any Systems of the present disclosures, any type of Participant, may be Compensated. FIG. 15B shows, alternatively how Supervisors may be Compensated.

FIG. 15A, 15300, represents Data Captured regarding an Entity, according to Systems of the present disclosures. This Data may be of Evaluation or Education or any other activity of which Data may be Captured. Thus the Entity may be acting as an Evaluator or Educator, buyer, seller, any type of Provider, Recipient, or other Participant, involved in the presentation or exchange of Data or in any other role, Providing or engaging in the Performance of any Entity(ies) of Value, according to the Systems of the present disclosures, such as discussed elsewhere and in description related to FIG. 14. FIG. 15, 15305, depicts (a) Compensation Terms Determination or Agreement System(s) of the present disclosures, of which the Entity may be a Participant or be acting under. Such (a) System(s) of, Compensation Terms Determination or Agreement, would comprise data processing and data exchange or communication between Entities to determine or execute Compensation terms and/or Compensation agreements as Compensation for Performance of any of the Entities of Value taught by the present disclosures (such as including but not limited to, Evaluation, Providing Intellectual Input, Intellectual Output, Education including the selection and formulation of, arranging for or engaging in Cross Linking, etc.). Compensation terms and agreements may be determined and agreed to as discussed elsewhere herein, such as through flat fee arrangements, fixed prices for any Entities of Value, or services or auction or bidding arrangements, etc. FIG. 15A, 15325, Compensation Providing System, represents that Compensation, which may have been determined according to, 15305 Compensation or Terms Determination or Agreement System(s), is Provided to an Entity that acts as a Provider of any Entit(y)ies of Value of the present disclosures such as including but not limited to, Evaluation, Providing Intellectual Input, Intellectual Output Education including the selection and formulation of, arranging for or engaging in Cross Linking (Cross Linking Entity), etc. This Compensation may be made to any non-Supervisory Entity such as an Evaluator, Educator, or Cross Linking Entity, as directly determined and from the Recipient of the Performance of such Entity of Value(s) or Cross Linking.

FIG. 15A, 15315 depicts that in an embodiment (a) System(s) may exist (that may be optional for (an) Entity(ies) to choose whether or not to utilize), that allow(s) storage of Data on Compensation due from (a) specific Entity (ies), for (an) Entity(ies) of Value, of the present disclosures, that may be Provided. Such Data of Compensation due, is stored in a database or databases that may be in one location or distributed over any network(s) or system(s) of communication. This(ese) System(s), we will term Credit Accounting System(s) (CA). CA(s), will allow a delay from the time that Compensation is agreed to or determined, to the time it may be paid or transferred. This transfer may be for example, but not limited to, after work (or the Performance of any Entities of Values taught by the present disclosures such as Evaluation, Education, Intellectual Input, Cross Linking, etc.), upon which the Compensation Terms Determination and Agreement are based (is) are Performed. This transfer may be made, for example, after specific Performance or Performances occur in the future, or after Performances are Performed by the Recipient Entity within a certain subject category in which the Provider of the Entity(ies) of Value has contributed, as discussed above in the Cobol example and elsewhere. In another embodiment, this Compensation due, may be from any income that is derived in the future from any source, as similar for example to how a legal financial debt may be due, from any income to a specific Entity.

Compensation may be due or made (according to the teachings of the present disclosure) to (an) Entity(ies) that Provide(s) any Entity(ies) of Value according to any future specified, accepted, or agreed to Data Capture or Accreditation attributed to (a) Recipient Entity(ies), whether or not it is found that such Recipient Entity(ies) has(ve) received Compensation. In other words any Data Capture or Accreditation attributed to a Recipient Entity, which occurs after Providing of an Entity of Value or promise of Providing of an Entity of Value by another Entity, may be used to trigger Compensation or Compenation due to the Providing Entity. For example, someone who has Accreditation or Data Capture regarding Intellectual Output (and possibly Intellectual Input to others) in Automobile Transmission repair (Entity X), is a Recipient of Intellectual Output on Automobile Body repair from another Entity (Entity Y). It may be accepted, agreed to or specified (according to the System(s) of the present disclosure) that, Entity Y, receives Compensation or Compensation due From Entity X, at some time in the future when Entity X has Data Captured or receives additional Accreditation for Providing Intellectual Output to others in Auto Transmission Repair, whether or not (as may be specified between both Entities) Entity X receives Compensation for Providing such Intellectual Output on Transmission Auto Repair.

FIG. 15A, 15320, represents (a) Data Capture Accounting Database System(s) (DAD). DAD(s) may provide Data Capture and/or (a) database(s) on any overall or partial Compensation (an) Entity(ies) may be due or receives, from any Performances (an) Entity(ies) may engage in and/or from select areas, types, or specific Performances (optionally including Categorization Data of this Data of Performance(s)) of any Entities of Value that (an) Entity(ies) may engage in. The database(s) or Data Capture of (a) DAD(s), may also or alternatively, for example, access, facilitate access to, or store Data Captured specific to any areas of Performance or Categorized Data on Performance(s) (which may include Data on the substance of (a) Performance(s), such as Data on the Intellectual Output, Intellectual Input, Education, etc. Performed) or overall Data Capture specific to any Entity which may be the Accreditation of that Entity. For example, regarding the Cobol example above, Data Capture may be made accessible via the DAD, for Data on Performance(s) of Intellectual Output in Cobol by an Entity, programmer, which may occur after receiving Intellectual Input, Evaluation, or Education from the professor or graduate student who Performed or acted to Evaluate and/or Educate the Entity, programmer. This last said, “Data Captured and made accessible via the DAD”, is useful because, as explained in the Cobol example above, the Cobol professor or graduate student programmer, Evaluator and/or Educator, may be Compensated by his Recipient based upon Compensation for work done in Cobol that the Recipient later receives. The line connecting 15320 and 15325 illustrates that Compensation may be Provided, via the Compensation Providing System 15325, based (optionally utilizing any data processing or Capture System(s) of the present disclosures such as Data Filtering, Data Parsing, etc. of system 806) on Data Captured and utilized from the preceding System(s) such as 300,305,315, and/or 320.

To summarize, using the case of the Cobol example above, the Entity of whom Data is Captured in 15300, might be the “professor or graduate student of computer science” who acts as an Evaluator for the Recipient, “programmer” in Data Captured on Intellectual Output, Categorized as work done in Cobol. Via, 15305 Compensation Terms Determination or Agreement System(s), this said Evaluator could enter into an agreement with the programmer to be Compensated from any Compensation said “programmer” receives for any later work or Intellectual Output done by said “programmer” regarding Cobol, of which Data may be Captured. Based upon the terms of Compensation from System(s) 15305 minus any Compensation already transferred or accounted for to the said “professor or graduate student” Evaluator of this example, the 15315 Credit Accounting System(s) could store or provide data on Compensation due from “programmer” to Evaluator. As discussed above, 15320 would Capture Data on when the “programmer” receives Compensation for future Intellectual Output Categorized in Cobol, activating (in an embodiment, automatically activating System(s) of 15325 by sending data to it (them)), said System(s) 15325 being (a) System(s) to Provide Compensation, to the said “professor” Evaluator based upon Data Captured and processed by the preceding Systems.

Any of the Systems discussed above may function or interact with varying degrees of automation using methods and systems of data processing and data communication known in the art, in conjunction with the System(s) of the present disclosures.

FIG. 15, 1535 depicts that Data Capture may be performed for any of the Data of any of the Systems depicted in FIG. 15A and that any System(s) of the present disclosures may be utilized or incorporated where applicable by any of these Systems of FIG. 15A. FIG. 16 depicts system 806 wherein systems of Supervision [No.] and Compensation[No.] such as those described above may interact with other Systems of the present disclosures. As depicted by FIG. 16, the System(s) of FIGS. 14, 15a and 15b which are Systems of Compensation and Supervision may be incorporated into System 806 of FIG. 9, which is (a) centralized System(s) that unifies Systems of the present disclosures to be utilized for a plurality of Participants, whether the elements forming the System of FIG. 16 are in one location or spread out over multiple locations within any number of sites, networks, or locations on (a) system(s) of communication. Thus Data Capture may be automatically or otherwise performed on any Data generated through the functions of any Systems of FIG. 14, 15A, 15B or 16 or 17. (A) System(s) of identification of Data which may be Captured as discussed above and elsewhere regarding the use of passive or active identifiers or other means, may be used to Capture Data from any of the steps of any of these Systems In addition Data Capture, Data Filtering, Catregorization, Data Parsing, etc. as depicted in FIG. 16 and discussed above may be used to match Supervisors and non-Supervisory Evaluators with any Entities as discussed elsewhere. Thus any of the Systems of the present disclosures may interact and function technically with varying degrees of automation.

FIG. 15B, 1550 depicts that supervisor Compensation may be determined by sources relatively independent of those used to determine Compensation for non-supervisory Evaluators, Educators, CrossLinkers, etc., as discussed elsewhere in the present disclosure. 1560 depicts transfer of Compensation to Supervisors. As described above any of the functions of FIG. 15B may interact with the other Systems of the present disclosures to technically provide varying degrees of automation.

Any of the features of the present disclosure may be distributed over one site such as for example a website or webpage or discrete database or location(s) over a network or multiple networks. This may of course include any site(s) or locations(s) of user interfacing with the System(s), where (a) user(s), Entit(y)ies or Particiapants may utilize the System(s), for example over one website or many or any websites or location(s) on any network that they communicate or engage in activit(y)ies over. Thus for example but not limited to, Supervision or Compensation, or any of the System(s) taught herein, may be located or occur directly over or on the site(s) or system(s), such as including but not limited to, of Ebay or Amazon.com or Youtube.com or Google or they may occur or be located on (a) discrete website(s) or network(s) location (s) dedicated to the System(s) of the present disclosures.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method of accumulating accreditation, comprising:
identifying evaluations, from different sources relating to at least one entity;
accumulating evaluations associated with the at least one entity to create an accreditation associated with the at least one entity,
wherein at least one non-recipient evaluator of the entity provides an evaluation absent the receipt of a product or service provided by the entity; and
utilizing a compensation system to compensate the evaluators, including the at least one non-recipient evaluator, based on compensation received by the at least one entity for products or services relating to the accreditation.

2. The method of claim 1 further comprising:
locating evaluations on a computer network.

3. The method of claim 1 wherein the evaluations concern at least one of an entity of value, intellectual output, intellectual input, education or performance associated with the at least one entity.

4. The method of claim 1 further comprising:
locating evaluations on at least one of the Internet, World Wide Web (WWW), a local area network, and a phone system network.

5. The method of claim 1 wherein the located evaluations are filtered, categorized, accessed and stored.

6. A method of recommending education comprising:
analyzing at least one of evaluations, work experience and education associated with at least one entity; and
recommending intellectual input or education to the at least one entity based on said analysis, wherein a method or methods of supervision and/or compensation are utilized.

7. A system or systems of accumulating accreditation, comprising:
locating and/or identifying evaluations from different sources relating to at least one entity; and
accumulating evaluations associated with the at least one entity to create an accreditation associated with the at least one entity, wherein a system or systems of supervision and/or compensation are utilized.

8. A method of accumulating accreditation, the method comprising:
identifying an evaluation from at least one source relating to at least one entity; and
accumulating evaluations associated with the at least one entity to create an accreditation associated with the at least one entity, wherein, data is captured specific to an entity by using an identifier specific to the entity that accompanies data related to such entity.

9. The method of claim 8, wherein an identifier specific to the entity is on a participant's computer.

10. The method of claim 8 wherein an identifier is a cookie.
